(19) United States
(12) Patent Application Publication
(10) Pub. No.: US 2003/0115075 A1
(43) Pub. Date: Jun. 19, 2003

(54) Communication ameliorator employing the Bluetooth protocol

(75) Inventor: Michael Zunke, Tel Aviv (IL)

Correspondence Address: Ladas & Parry, 26 West 61st Street, New York, NY, 10023, US

(73) Assignee: ALADDIN KNOWLEDGE SYSTEMS LTD.

(21) Appl. No.: 10/024,837

(22) Filed: Dec. 19, 2001

(51) Int. Cl. G06F 17/60

(52) U.S. Cl. 705/1

(57) ABSTRACT

A system and method for use in a communication network and including at least one first device, at least one second device and a communication quality ameliorator. The communication quality ameliorator includes a first interface providing first interaction with said at least one first device and a second interface providing second interaction with said at least one second device, said second interaction including at least BLUETOOTH® communication.

### FIELD OF THE INVENTION

The present invention relates to communications quality amelioration generally.

### BACKGROUND OF THE INVENTION

The following publications are believed to represent the state of the art:

“BLUETOOTH® specifications core, Version 1.0b”, Dec. 1, 1999, pages 149-177;

“BLUETOOTH® specifications profile, Version 1.0b”, Dec. 1 1999, pages 33-36;

“BLUETOOTH® “hot spot” appliance contains tiny Linux server”, Rick Lehrbaum, ZD News, May 15, 2000;

“Wireless Lans”, Kerry T. Renshaw, Apr. 10, 2000.

### SUMMARY OF THE INVENTION

This invention seeks a system and methodology for communication employing a communications quality ameliorator and using a BLUETOOTH® communication protocol

There is thus provided in accordance with a preferred embodiment of the present invention a system for use in a communication network. The system includes at least one first device, at least one second device and a communication quality ameliorator, which includes a first interface providing first interaction with the first device and a second interface providing second interaction with the second device, the second interaction including at least BLUETOOTH® communication.

There is also provided in accordance with another preferred embodiment of the present invention a system for use in a communication network. The system includes at least one first device, at least one second device and a communications quality ameliorator, which includes a first interface providing interaction with the first device and a second interface providing interaction with the second device, the second device being required to conduct certain communications only via the communications quality ameliorator, the interaction including at least BLUETOOTH® communication.

There is also provided in accordance with yet another preferred embodiment of the present invention a communications quality ameliorator. The communications quality ameliorator includes a first interface providing interaction with the first device and a second interface providing interaction with the second device, the interaction including at least BLUETOOTH® communication.

There is further provided in accordance with another preferred embodiment of the present invention a method for use in a communication network. The method includes at least one amelioration functionality, a first interaction between the amelioration functionality and the first device and a second interaction between the amelioration functionality and at least one second device, the second interaction including at least BLUETOOTH® communication.

Further in accordance with preferred embodiment of the present invention the communication quality ameliorator provides a communication security functionality, a performance amelioration functionality, a communication availability functionality and/or a communication accountability functionality.

Additionally in accordance with preferred embodiment of the present invention the communication quality ameliorator provides a firewall functionality, a content inspection functionality, an authentication functionality, a proxy functionality, a communication monitoring functionality, a load balancing functionality, a caching functionality, a quality of service functionality, an accounting functionality and/or a billing functionality.

Preferably, the quality ameliorator is portable.

Still further in accordance with preferred embodiment of the present invention the communication quality ameliorator includes at least one of the following functionalities: a communication monitoring functionality, an accounting functionality, a billing functionality, a firewall functionality, a content inspection functionality, a proxy functionality, a caching functionality, a quality of service functionality, an encryption functionality, an authentication functionality and a load balancing functionality.

Alternatively, the communications quality ameliorator is stationary.

Further in accordance with preferred embodiment of the present invention the second interaction includes at least principally of BLUETOOTH® communication.

Still further in accordance with preferred embodiment of the present invention the first interaction includes at least some non-BLUETOOTH® communication.

Further in accordance with preferred embodiment of the present invention the second interaction includes at least principally BLUETOOTH® communication.

Preferably, the first interaction includes at least principally of BLUETOOTH® communication with an access point.

Moreover in accordance with preferred embodiment of the present invention the second interaction includes at least principally of BLUETOOTH® communication.

Further in accordance with preferred embodiment of the present invention the first interaction includes at least some non-BLUETOOTH® communication between the access point and the first device.

Still further in accordance with preferred embodiment of the present invention both the first and second interactions include at least principally of BLUETOOTH® communication.

Additionally in accordance with preferred embodiment of the present invention the first device includes a server.

Still further in accordance with preferred embodiment of the present invention the first device includes a plurality of first devices.

Preferably, the first device includes at least a printer, a web site, a computer, a computer screen, a cordless telephone base unit, an authenticator and a domestic appliance.

Additionally in accordance with preferred embodiment of the present invention the at least second device includes a client.

Further in accordance with preferred embodiment of the present invention the second device includes a plurality of second devices.

Preferably, the second device includes at least an electronic wallet, a telephone, a cordless telephone handset, a personal digital assistant, a portable computer, a keyboard, a mouse and a remote controller.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system and methodology for communication employing a communications quality ameliorator and using a BLUETOOTH® communication protocol in accordance with a preferred embodiment of the present invention;

FIG. 2 is a simplified pictorial illustration of a system and methodology for communication employing a communications quality ameliorator and using a BLUETOOTH® communication protocol in accordance with a preferred embodiment of the present invention wherein at least one wired connection is provided with the communications quality ameliorator;

FIG. 3 is a simplified pictorial illustration of a system and methodology for communication employing a communications quality ameliorator and using a BLUETOOTH® communication protocol in accordance with a preferred embodiment of the present invention wherein the BLUETOOTH® communication protocol is employed for only part of said communication;

FIG. 4 is a simplified pictorial illustration of a system and methodology for communication employing a communications quality ameliorator and using a BLUETOOTH® communication protocol in accordance with a preferred embodiment of the present invention wherein direct connections are provided between the communications quality ameliorator and a plurality of devices;

FIG. 5A is a simplified pictorial illustration of a system and methodology for communication employing a communications quality ameliorator of the type shown in FIG. 1, wherein the communications quality ameliorator provides a communication monitoring functionality;

FIG. 5B is a simplified pictorial illustration of a system and methodology for communication employing a communications quality ameliorator of the type shown in FIG. 1, wherein the communications quality ameliorator provides a firewall functionality;

FIG. 5C is a simplified pictorial illustration of a system and methodology for communication employing a communications quality ameliorator of the type shown in FIG. 1, wherein the communications quality ameliorator provides a content inspection functionality;

FIG. 5D is a simplified pictorial illustration of a system and methodology for communication employing a communications quality ameliorator of the type shown in FIG. 1, wherein the communications quality ameliorator provides a proxy functionality;

FIG. 5E is a simplified pictorial illustration of a system and methodology for communication employing a communications quality ameliorator of the type shown in FIG. 1, wherein the communications quality ameliorator provides a load balancing functionality;

FIG. 6A is a simplified pictorial illustration of a system and methodology for communication employing a communications quality ameliorator of the type shown in FIG. 2, wherein the communications quality ameliorator provides a communication monitoring functionality;

FIG. 6B is a simplified pictorial illustration of a system and methodology for communication employing a communications quality ameliorator of the type shown in FIG. 2, wherein the communications quality ameliorator provides a firewall functionality;

FIG. 6C is a simplified pictorial illustration of a system and methodology for communication employing a communications quality ameliorator of the type shown in FIG. 2, wherein the communications quality ameliorator provides a content inspection functionality;

FIG. 6D is a simplified pictorial illustration of a system and methodology for communication employing a communications quality ameliorator of the type shown in FIG. 2, wherein the communications quality ameliorator provides a proxy functionality;

FIG. 6E is a simplified pictorial illustration of a system and methodology for communication employing a communications quality ameliorator of the type shown in FIG. 2, wherein the communications quality ameliorator provides a load balancing functionality;

FIG. 7A is a simplified pictorial illustration of a system and methodology for communication employing a communications quality ameliorator of the type shown in FIG. 3, wherein the communications quality ameliorator provides a communication monitoring functionality;

FIG. 7B is a simplified pictorial illustration of a system and methodology for communication employing a communications quality ameliorator of the type shown in FIG. 3, wherein the communications quality ameliorator provides a firewall functionality;

FIG. 7C is a simplified pictorial illustration of a system and methodology for communication employing a communications quality ameliorator of the type shown in FIG. 3, wherein the communications quality ameliorator provides a content inspection functionality;

FIG. 7D is a simplified pictorial illustration of a system and methodology for communication employing a communications quality ameliorator of the type shown in FIG. 3, wherein the communications quality ameliorator provides a proxy functionality;

FIG. 7E is a simplified pictorial illustration of a system and methodology for communication employing a communications quality ameliorator of the type shown in FIG. 3, wherein the communications quality ameliorator provides a load balancing functionality;

FIG. 8A is a simplified pictorial illustration of a system and methodology for communication employing a communications quality ameliorator of the type shown in FIG. 4, wherein the communications quality ameliorator provides a communication monitoring functionality;

FIG. 8B is a simplified pictorial illustration of a system and methodology for communication employing a communications quality ameliorator of the type shown in FIG. 4, wherein the communications quality ameliorator provides a firewall functionality;

FIG. 8C is a simplified pictorial illustration of a system and methodology for communication employing a communications quality ameliorator of the type shown in FIG. 4, wherein the communications quality ameliorator provides a content inspection functionality;

FIG. 8D is a simplified pictorial illustration of a system and methodology for communication employing a communications quality ameliorator of the type shown in FIG. 4, wherein the communications quality ameliorator provides a proxy functionality;

FIG. 8E is a simplified pictorial illustration of a system and methodology for communication employing a communications quality ameliorator of the type shown in FIG. 4, wherein the communications quality ameliorator provides a load balancing functionality;

FIG. 9A is a simplified pictorial illustration of a system and methodology for communication employing a communications quality ameliorator and using a BLUETOOTH® communication protocol in accordance with a preferred embodiment of the present invention wherein a device is required to conduct certain communications only via the communications quality ameliorator;

FIG. 9B is a simplified pictorial illustration of a system and methodology for communication employing a communications quality ameliorator and using a BLUETOOTH® communication protocol in accordance with a preferred embodiment of the present invention wherein a device is required to conduct certain communications only via said communications quality ameliorator;

FIG. 9C is a simplified pictorial illustration of a system and methodology for communication employing a communications quality ameliorator and using a BLUETOOTH® communication protocol in accordance with a preferred embodiment of the present invention wherein a device is required to conduct certain communications only via said communications quality ameliorator;

FIG. 9D is a simplified pictorial illustration of a system and methodology for communication employing a communications quality ameliorator and using a BLUETOOTH® communication protocol in accordance with a preferred embodiment of the present invention wherein a device is required to conduct certain communications only via said communications quality ameliorator;

FIG. 10A is a simplified pictorial illustration of a system and methodology for communication employing a portable communications quality ameliorator and using a BLUETOOTH® communication protocol in accordance with a preferred embodiment of the present invention;

FIG. 10B is a simplified pictorial illustration of a system and methodology for communication employing a portable communications quality ameliorator and using a BLUETOOTH® communication protocol in accordance with another preferred embodiment of the present invention;

FIG. 10C is a simplified pictorial illustration of a system and methodology for communication employing a portable communications quality ameliorator and using a BLUETOOTH® communication protocol in accordance with yet another preferred embodiment of the present invention;

FIG. 11A is a simplified pictorial illustration of a system and methodology for communication employing a stationary communications quality ameliorator and using a BLUETOOTH® communication protocol in accordance with a preferred embodiment of the present invention;

FIG. 11B is a simplified pictorial illustration of a system and methodology for communication employing a stationary communications quality ameliorator and using a BLUETOOTH® communication protocol in accordance with another preferred embodiment of the present invention;

FIG. 11C is a simplified pictorial illustration of a system and methodology for communication employing a stationary communications quality ameliorator and using a BLUETOOTH® communication protocol in accordance with yet another preferred embodiment of the present invention;

FIG. 12 is a simplified pictorial illustration of a system and methodology for communication employing a portable communications quality ameliorator and using a BLUETOOTH® communication protocol in accordance with a preferred embodiment of the present invention; and

FIG. 13 is a simplified pictorial illustration of a system and methodology for communication employing a stationary communications quality ameliorator and using a BLUETOOTH® communication protocol in accordance with a preferred embodiment of the present invention.

### DETAILED DESCRIPTION OF PREFERRED EMBODIMENTS

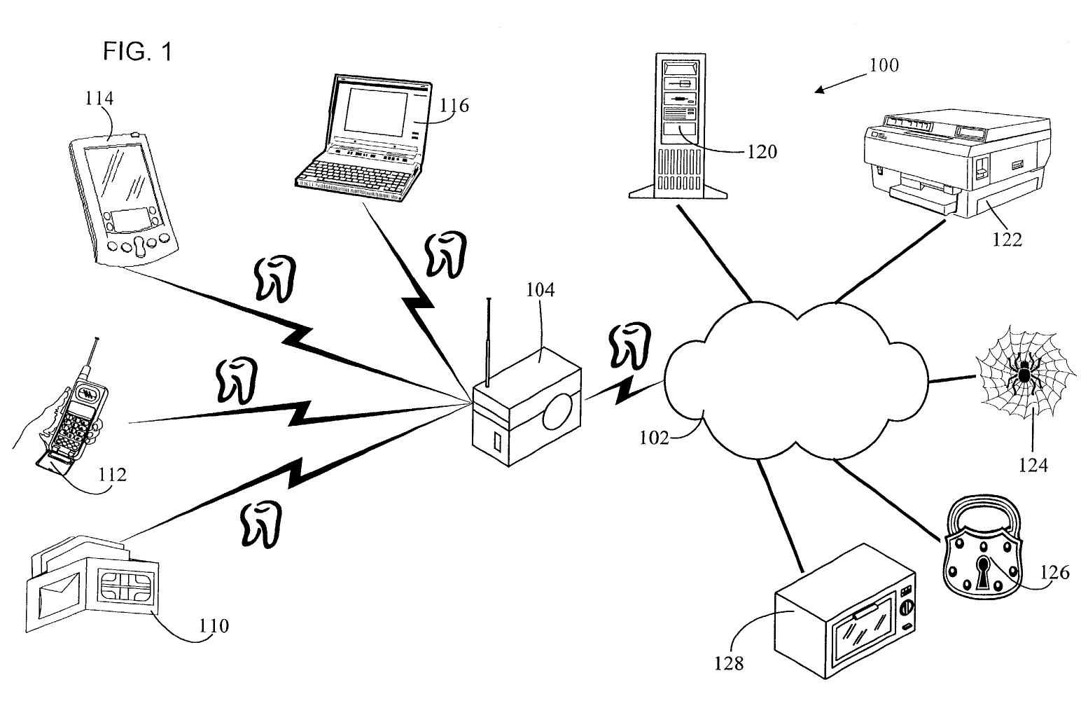

Reference is now made to FIG. 1, which is a simplified pictorial illustration of a system and methodology for communication employing a communications quality ameliorator and using a BLUETOOTH® communication protocol in accordance with a preferred embodiment of the present invention.

Throughout the specification and claims, the term “communications quality ameliorator” is used to denote a device, which enhances at least one characteristic of communications therethrough. Such characteristics include security, performance, accountability and availability

Preferably, a communications quality ameliorator may have at least one of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

As seen in FIG. 1, there is provided a system 100 for communication with a communication network, such as the Internet, herein designated by reference numeral 102 or with an intranet. The system 100 is characterized in that it employs a communications quality ameliorator 104 which communicates with the communication network at least partially using a BLUETOOTH® communication protocol.

Four different types of devices are shown here in BLUETOOTH® communication via communications quality ameliorator 104 and communication network 102 with one or more servers. The devices include, for example, an electronic wallet 110, a telephone 112, a personal digital assistant 114 and a notebook PC 116. The servers include, for example, a computer 120, a printer 122, a web site 124, an authenticator 126 and a microwave oven 128. It is appreciated that any suitable device or server may alternatively or additionally communicate via communications quality ameliorator 104 and communications network 102.

Communications quality ameliorator 104 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 116 or personal digital assistant 114, communicates with communications quality ameliorator 104 at least partially by using a BLUETOOTH®0 communication protocol, symbolized by a tooth.

Further in accordance with a preferred embodiment of the present invention, the communications quality ameliorator 104 communicates with the communication network 102 at least partially by using a BLUETOOTH® communication protocol, symbolized by a tooth, and thence with one or more server, such as printer 122 or web site 124.

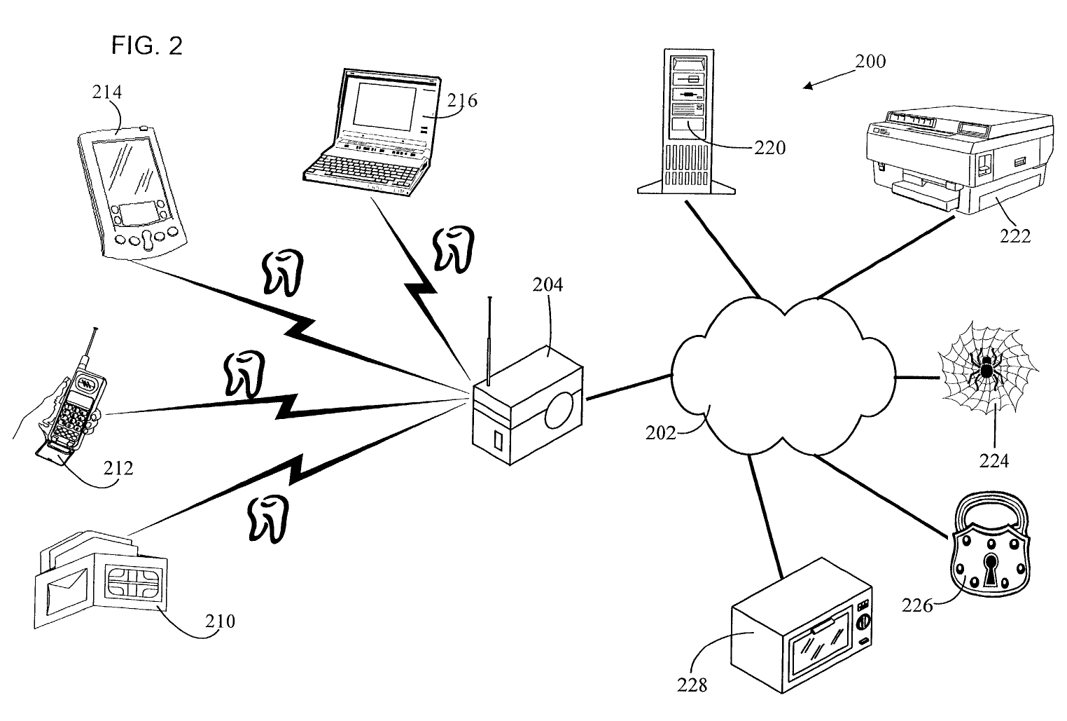

Reference is now made to FIG. 2, which is a simplified pictorial illustration of a system and methodology for communication employing a communications quality ameliorator and using a BLUETOOTH® communication protocol in accordance with another preferred embodiment of the present invention. As seen in FIG. 2, there is provided a system 200 for communication with a communication network, such as the Internet, herein designated by reference numeral 202 or with an intranet. The system 200 is characterized in that it employs a communications quality ameliorator 204 which communicates with the communication network by any suitable communication protocol.

Four different types of devices are shown here in BLUETOOTH® communication via communications quality ameliorator 204 and communication network 202 with one or more servers. The devices include, for example, an electronic wallet 210, a telephone 212, a personal digital assistant 214 and a notebook PC 216. The servers include, for example, a computer 220, a printer 222, a web site 224, an authenticator 226 and a microwave oven 228. It is appreciated that any suitable device or server may alternatively or additionally communicate via communications quality ameliorator 204 and communications network 202.

Communications quality ameliorator 204 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 216 or personal digital assistant 214, communicates with communications quality ameliorator 204 at least partially by using a BLUETOOTH® communication protocol, symbolized by a tooth.

Further in accordance with a preferred embodiment of the present invention, the communications quality ameliorator 204 communicates with the communication network 202 by any suitable communication protocol and thence with one or more servers, such as printer 222 or web site 224.

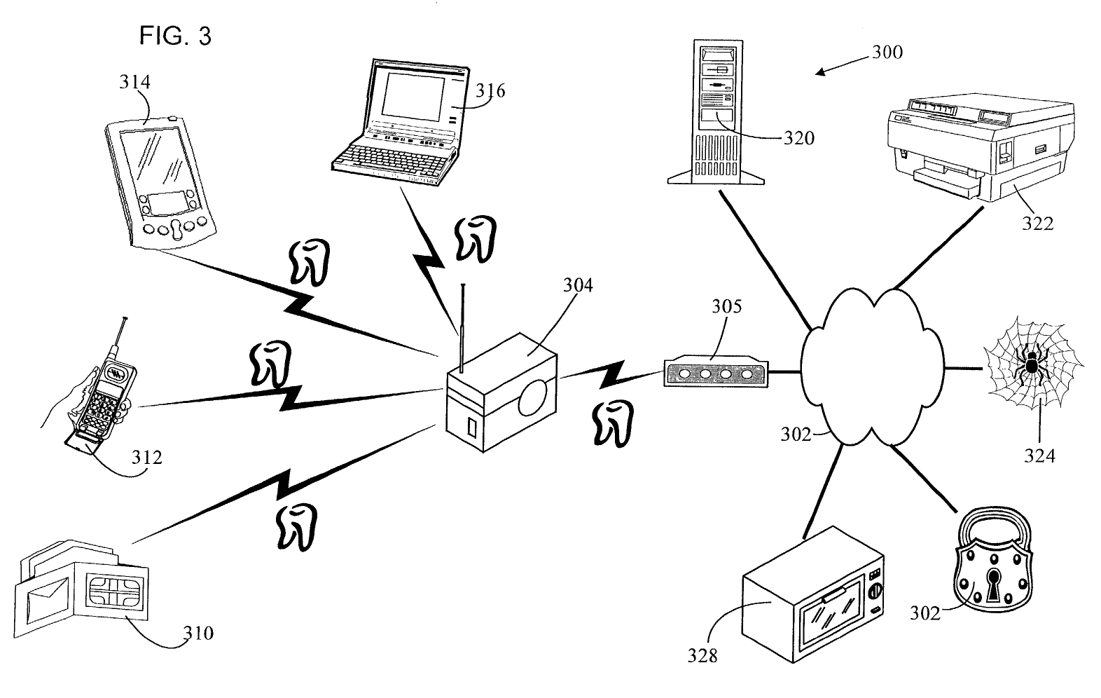

Reference is now made to FIG. 3, which is a simplified pictorial illustration of a system and methodology for communication employing a communications quality ameliorator and using a BLUETOOTH® communication protocol in accordance with a preferred embodiment of the present invention. As seen in FIG. 3, there is provided a system 300 for communication with a communication network, such as the Internet, herein designated by reference numeral 302 or with an intranet. The system 300 is characterized in that it employs a communications quality ameliorator 304 which communicates with the communication network via an access point 305 preferably at least partially using a BLUETOOTH® communication protocol.

Four different types of devices are shown here in BLUETOOTH® communication via communications quality ameliorator 304 and communication network 302 with one or more servers. The devices include, for example, an electronic wallet 310, a telephone 312, a personal digital assistant 314 and a notebook PC 316. The servers include, for example, a computer 320, a printer 322, a web site 324, an authenticator 326 and a microwave oven 328. It is appreciated that any suitable device or server may alternatively or additionally communicate via communications quality ameliorator 304 and communications network 302.

Communications quality ameliorator 304 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 316 or personal digital assistant 314, communicates with communications quality ameliorator 304 at least partially by using a BLUETOOTH® communication protocol, symbolized by a tooth.

Further in accordance with a preferred embodiment of the present invention, the communications quality ameliorator 304 communicates with the communication network 302 via access point 305 preferably at least partially by using a BLUETOOTH® communication protocol, symbolized by a tooth, and thence with one or more servers, such as printer 322 or web site 324.

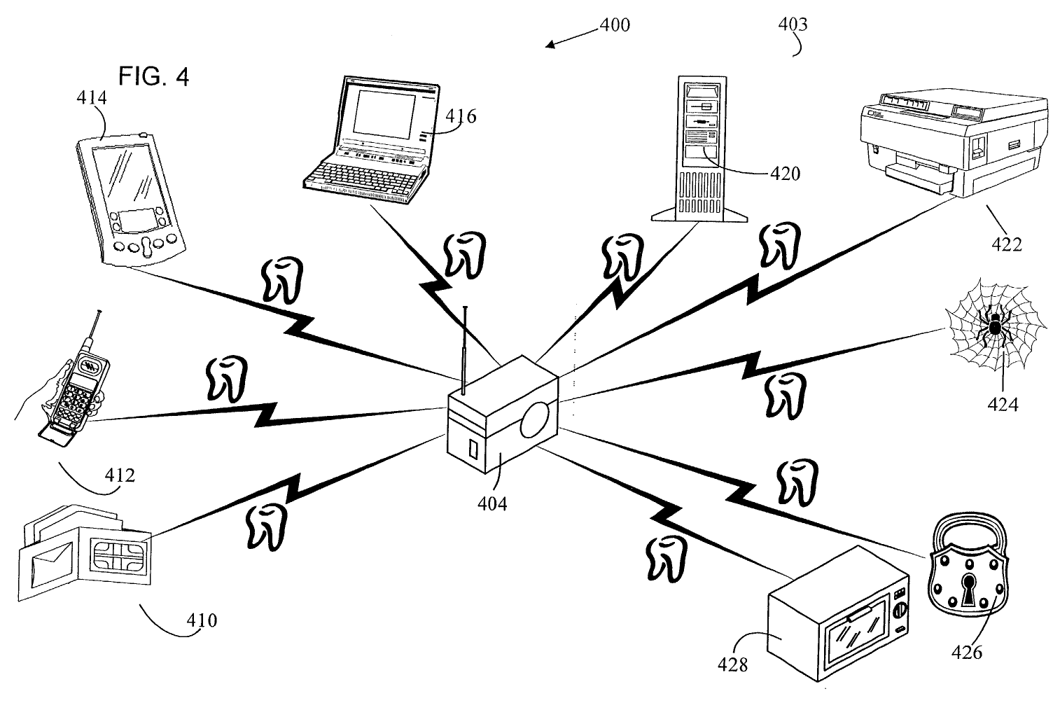

Reference is now made to FIG. 4, which is a simplified pictorial illustration of a system and methodology for communication employing a communications quality ameliorator and using a BLUETOOTH® communication protocol in accordance with a preferred embodiment of the present invention. As seen in FIG. 4, there is provided a system 400 for communication with one or more servers 403. The system 400 is characterized in that it employs a communications quality ameliorator 404 which communicates with the one or more servers 403 at least partially using a BLUETOOTH® communication protocol.

Four different types of devices are shown here in BLUETOOTH® communication via communications quality ameliorator 404 with one or more servers 403. The devices include, for example, an electronic wallet 410, a telephone 412, a personal digital assistant 414 and a notebook PC 416. The servers include, for example, a computer 420, a printer 422, a web site 424, an authenticator 426 and a microwave oven 428. It is appreciated that any suitable device or server may alternatively or additionally communicate via communications quality ameliorator 404.

Communications quality ameliorator 404 is preferably characterized in that it provides one or more of the following functionalities:

a communication monitoring functionality;

an accounting functionality;

billin functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 416 or personal digital assistant 414, communicates with communications quality ameliorator 404 at least partially by using a BLUETOOTH® communication protocol, symbolized by a tooth.

Further in accordance with a preferred embodiment of the present invention, the communications quality ameliorator 404 communicates with one or more servers 403 at least partially by using a BLUETOOTH® communication protocol, symbolized by a tooth.

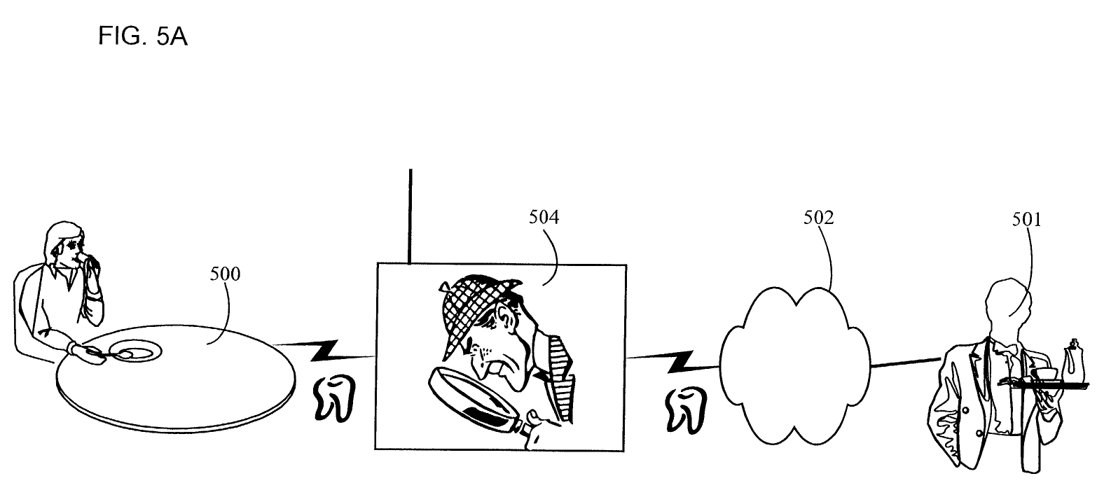

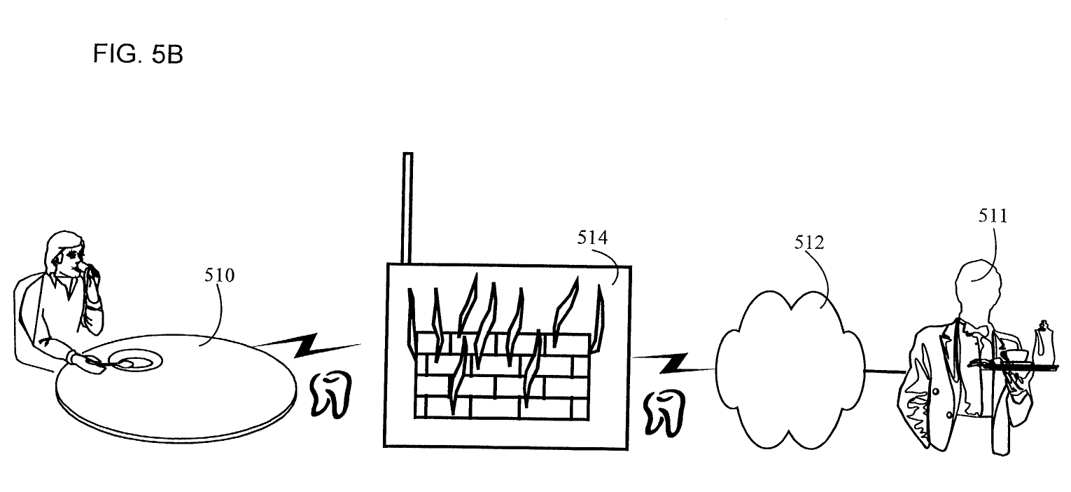

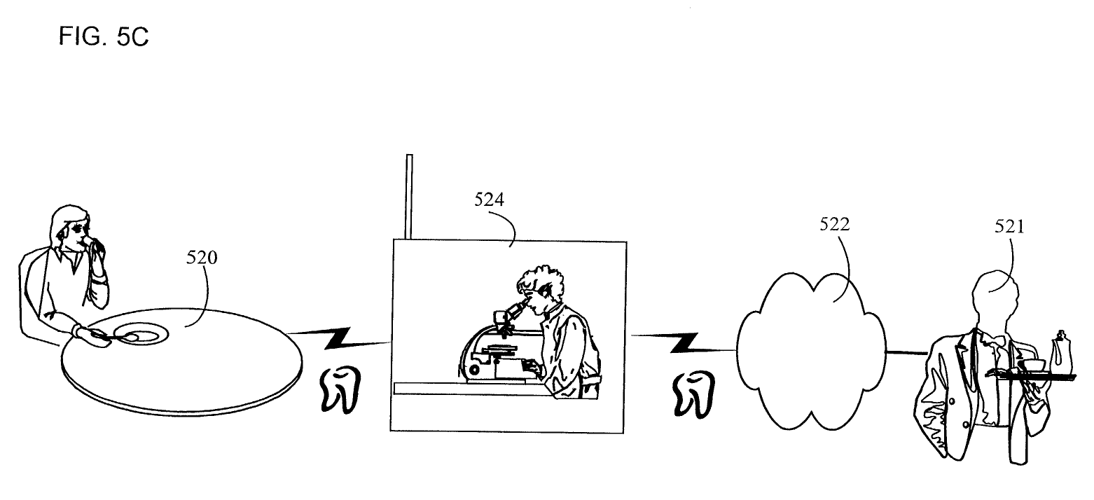

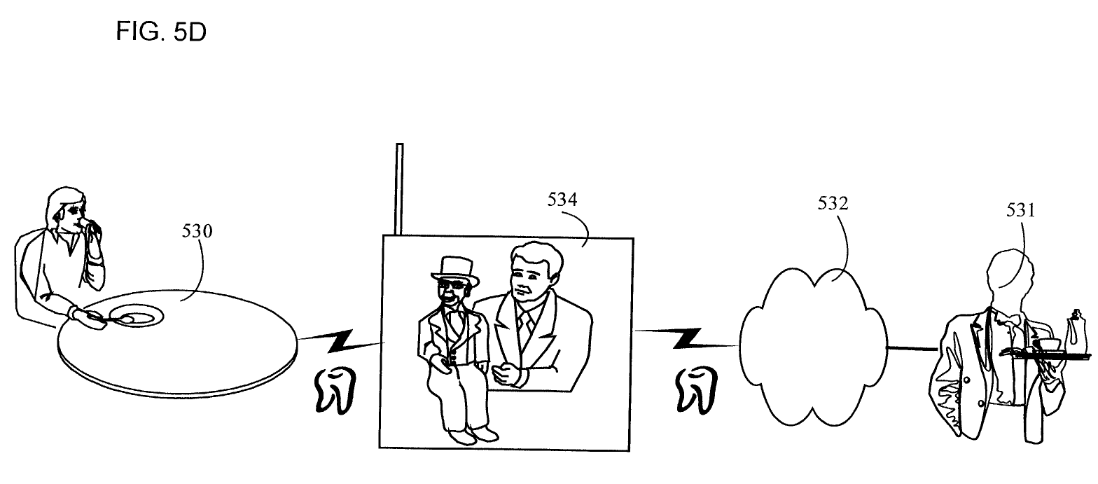

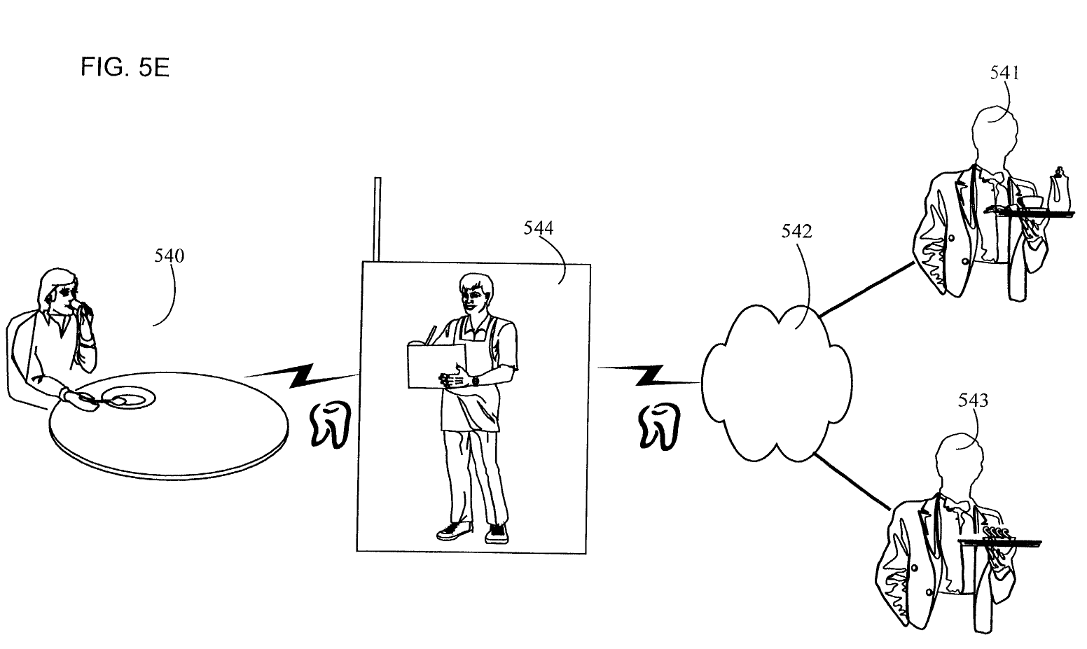

Reference is now made to FIG. 5A is a simplified pictorial illustration of a system and methodology for communication employing a communications quality ameliorator of the type shown in FIG. 1, wherein the communications quality ameliorator provides a communication monitoring functionality.

As seen in FIG. 5A a client, symbolized by a diner at a restaurant and indicated by reference numeral 500, communicates with a server, symbolized by a waiter and indicated by reference numeral 501 via a communications network 502. Communications to and from the client 500 pass via a communications quality ameliorator 504 which has communication monitoring functionality, symbolized by a detective. Preferably BLUETOOTH® communication protocols, symbolized by a tooth, are employed both for communications between the client 500 and the communications quality ameliorator 504 and between the communications quality ameliorator 504 and the communication network 502.

The communication monitoring functionality is any suitable functionality wherein the communications quality ameliorator 504 acts to monitor communications in order to sense and/or analyze information passing through it, without significantly affecting communication content or routing.

Reference is now made to FIG. 5B, which is a simplified pictorial illustration of a system and methodology for communication employing a communications quality ameliorator of the type shown in FIG. 1, wherein the communications quality ameliorator provides a firewall functionality.

As seen in FIG. 5B a client, symbolized by a diner at a restaurant and indicated by reference numeral 510, communicates with a server, symbolized by a waiter and indicated by reference numeral 511 via a communications network 512. Communications to and from the client 510 pass via a communications quality ameliorator 514 which has firewall functionality, symbolized by a fire blocking wall. Preferably BLUETOOTH® communication protocols, symbolized by a tooth, are employed both for communications between the client 510 and the communications quality ameliorator 514 and between the communications quality ameliorator 514 and the communication network 512.

The firewall functionality is any suitable functionality wherein the communications quality ameliorator 514 acts to block unauthorized connections through

Reference is now made to FIG. 5C, which is a simplified pictorial illustration of a system and methodology for communication employing a communications quality ameliorator of the type shown in FIG. 1, wherein the communications quality ameliorator provides a content inspection functionality.

As seen in FIG. 5C a client, symbolized by a diner at a restaurant and indicated by reference numeral 520, communicates with a server, symbolized by a waiter and indicated by reference numeral 521 via a communications network 522. Communications to and from the client 520 pass via a communications quality ameliorator 524 which has content inspection functionality, symbolized by a microscope examination. Preferably BLUETOOTH® communication protocols, symbolized by a tooth, are employed both for communications between the client 520 and the communications quality ameliorator 524 and between the communications quality ameliorator 524 and the communication network 522.

The content inspection functionality is any suitable functionality wherein the communications quality ameliorator 524 acts to combat malicious content passing through it.

Reference is now made to FIG. 5D, which is a simplified pictorial illustration of a system and methodology for communication employing a communications quality ameliorator of the type shown in FIG. 1, wherein the communications quality ameliorator provides a proxy functionality.

As seen in FIG. 5D a client, symbolized by a diner at a restaurant and indicated by reference numeral 530, communicates with a server, symbolized by a waiter and indicated by reference numeral 531 via a communications network 532. Communications to and from the client pass via a communications quality ameliorator 534 which has a proxy functionality, symbolized by a ventriloquist. Preferably BLUETOOTH® communication protocols, symbolized by a tooth, are employed both for communications between the client 530 and the communications quality ameliorator 534 and between the communications quality ameliorator 534 and the communication network 532.

The proxy functionality is any suitable functionality wherein the communications quality ameliorator 534 provides an agent which acts on behalf of the client.

Reference is now made to FIG. 5E, which is a simplified pictorial illustration of a system and methodology for communication employing a communications quality ameliorator of the type shown in FIG. 1, wherein the communications quality ameliorator provides a load balancing functionality.

As seen in FIG. 5E a client, symbolized by a diner at a restaurant and indicated by reference numeral 540, communicates with one or more server, symbolized by a drinks waiter and a food waiter and indicated respectively by reference numerals 541 and 543 preferably via a communications network 542.

Communications to and from the client 540 pass via a communications quality ameliorator 544 which has a load balancing functionality, symbolized by an order taker. Preferably BLUETOOTH® communication protocols, symbolized by a tooth, are employed both for communications between the client 540 and the communications quality ameliorator 544 and between the communications quality ameliorator 544 and the communication network 542.

It is appreciated that communication between communications quality ameliorator 544 and servers 541 and 543 may employ any combination of the communication methods of the type shown in FIGS. 1-4.

The load balancing functionality is any suitable functionality wherein the communications quality ameliorator 544 directs communications to one of a plurality of servers.

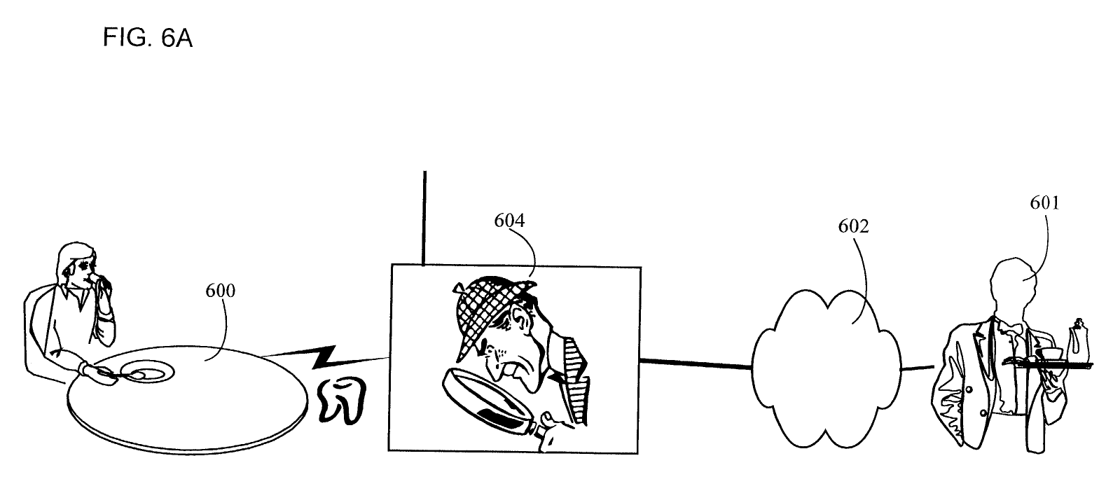

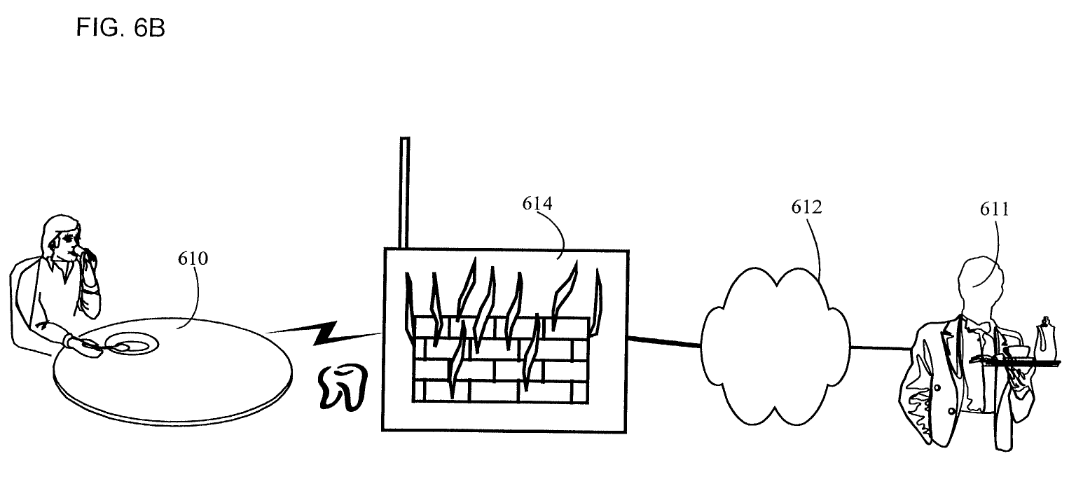

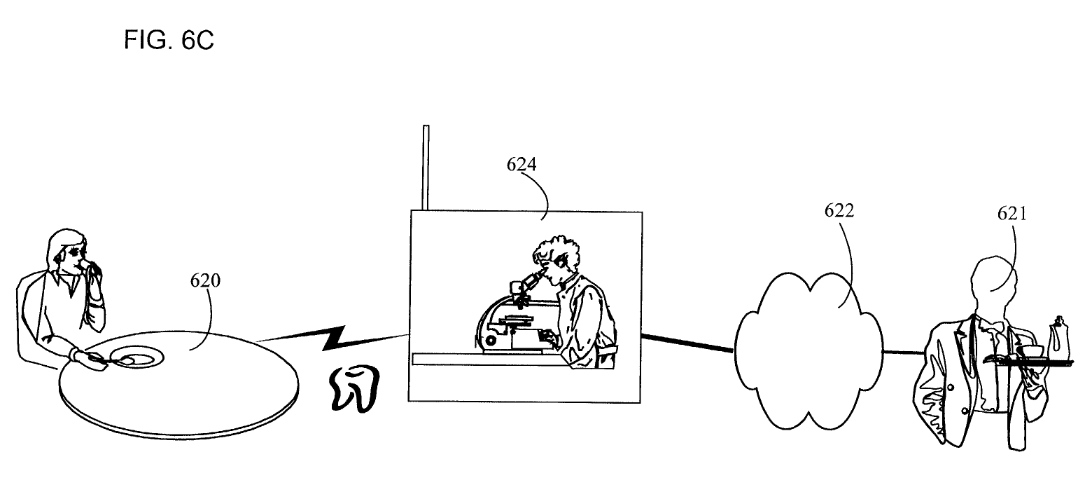

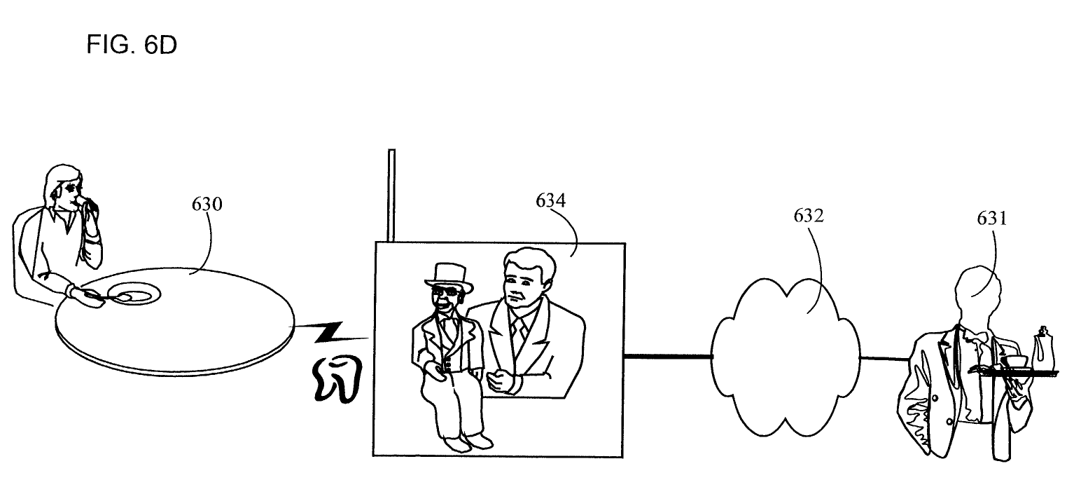

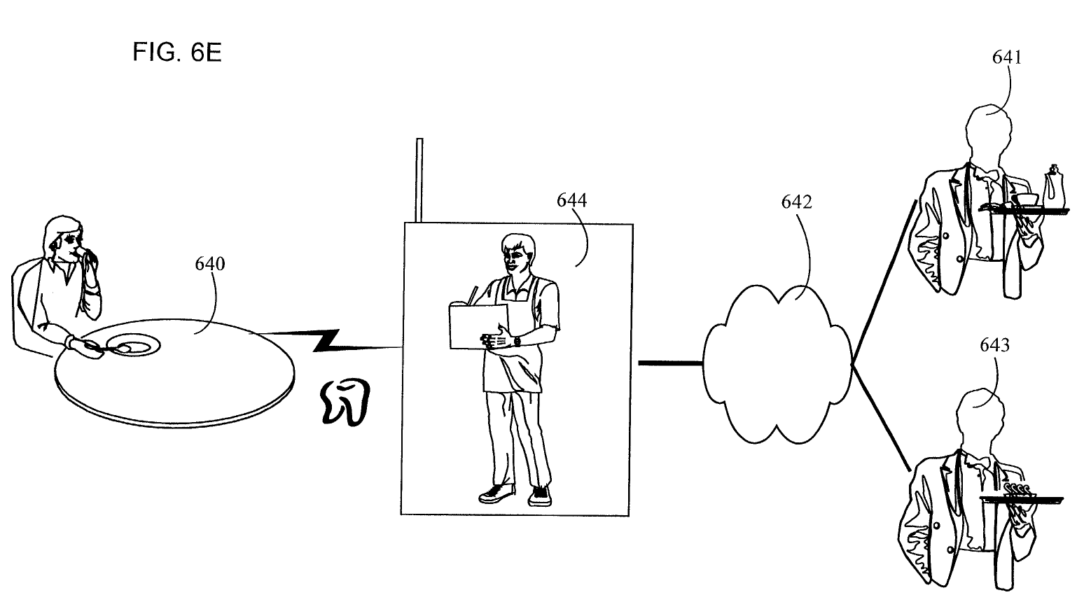

Reference is now made to FIG. 6A is a simplified pictorial illustration of a system and methodology for communication employing a communications quality ameliorator of the type shown in FIG. 2, wherein the communications quality ameliorator provides a communication monitoring functionality.

As seen in FIG. 6A a client, symbolized by a diner at a restaurant and indicated by reference numeral 600, communicates with a server, symbolized by a waiter and indicated by reference numeral 601 via a communications network 602. Communications to and from the client 600 pass via a communications quality ameliorator 604 which has communication monitoring functionality, symbolized by a detective. Preferably BLUETOOTH® communication protocol, symbolized by a tooth, is employed for communications between the client 600 and the communications quality ameliorator 604. Any suitable communication protocol may be employed for communications between the communications quality ameliorator 604 and the network 602.

The communication monitoring functionality is any suitable functionality wherein the communications quality ameliorator 604 acts to monitor communications in order to sense and/or analyze information passing through it, without significantly affecting communication content or routing.

Reference is now made to FIG. 6B, which is a simplified pictorial illustration of a system and methodology for communication employing a communications quality ameliorator of the type shown in FIG. 2, wherein the communications quality ameliorator provides a firewall functionality.

As seen in FIG. 6B a client, symbolized by a diner at a restaurant and indicated by reference numeral 610, communicates with a server, symbolized by a waiter and indicated by reference numeral 611 via a communications network 612. Communications to and from the client 610 pass via a communications quality ameliorator 614 which has firewall functionality, symbolized by a fire blocking wall. Preferably BLUETOOTH® communication protocol, symbolized by a tooth, is employed for communications between the client 610 and the communications quality ameliorator 614. Any suitable communication protocol may be employed for communications between the communications quality ameliorator 614 and the network 612.

The firewall functionality is any suitable functionality wherein the communications quality ameliorator 614 acts to block unauthorized connections through it.

Reference is now made to FIG. 6C, which is a simplified pictorial illustration of a system and methodology for communication employing a communications quality ameliorator of the type shown in FIG. 2, wherein the communications quality ameliorator provides a content inspection functionality;

As seen in FIG. 6C a client, symbolized by a diner at a restaurant and indicated by reference numeral 620, communicates with a server, symbolized by a waiter and indicated by reference numeral 621 via a communications network 622. Communications to and from the client 620 pass via a communications quality ameliorator 624 which has content inspection functionality, symbolized by a microscope examination. Preferably BLUETOOTH® communication protocol, symbolized by a tooth, is employed for communications between the client 620 and the communications quality ameliorator 624. Any suitable communication protocol may be employed for communications between the communications quality ameliorator 624 and the network 622.

The content inspection functionality is any suitable functionality wherein the communications quality ameliorator 624 acts to combat malicious content passing through it.

Reference is now made to FIG. 6D, which is a simplified pictorial illustration of a system and methodology for communication employing a communications quality ameliorator of the type shown in FIG. 2, wherein the communications quality ameliorator provides a proxy functionality.

As seen in FIG. 6D a client, symbolized by a diner at a restaurant and indicated by reference numeral 630, communicates with a server, symbolized by a waiter and indicated by reference numeral 631 via a communications network 632. Communications to and from the client 630 pass via a communications quality ameliorator 634 which has a proxy functionality, symbolized by a ventriloquist. Preferably BLUETOOTH® communication protocol, symbolized by a tooth, is employed for communications between the client 630 and the communications quality ameliorator 634. Any suitable communication protocol may be employed for communications between the communications quality ameliorator 634 and the network 632.

The proxy functionality is any suitable functionality wherein the communications quality ameliorator 634 provides an agent which acts on behalf of the client.

Reference is now made to FIG. 6E, which is a simplified pictorial illustration of a system and methodology for communication employing a communications quality ameliorator of the type shown in FIG. 2, wherein the communications quality ameliorator provides a load balancing functionality.

As seen in FIG. 6E a client, symbolized by a diner at a restaurant and indicated by reference numeral 640, communicates with one or more server, symbolized by a drinks waiter and a food waiter and indicated respectively by reference numerals 641 and 643 via a communications network 642. Communications to and from the client 640 pass via a communications quality ameliorator 644 which has a load balancing functionality, symbolized by an order taker. Preferably BLUETOOTH® communication protocol, symbolized by a tooth, is employed for communications between the client 640 and the communications quality ameliorator 644. Any suitable communication protocol may be employed for communications between the communications quality ameliorator 644 and the network 642.

It is appreciated that communication between communications quality ameliorator 644 and servers 641 and 643 may employ any combination of the communication methods of the type shown in FIGS. 1-4.

The load balancing functionality is any suitable functionality wherein the communications quality ameliorator 644 directs communications to one of a plurality of servers.

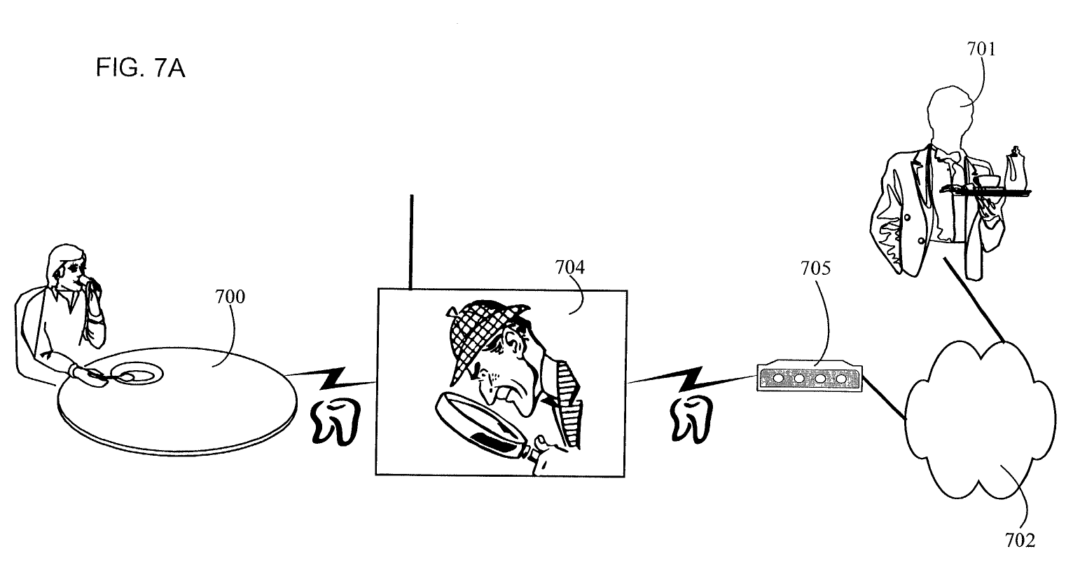

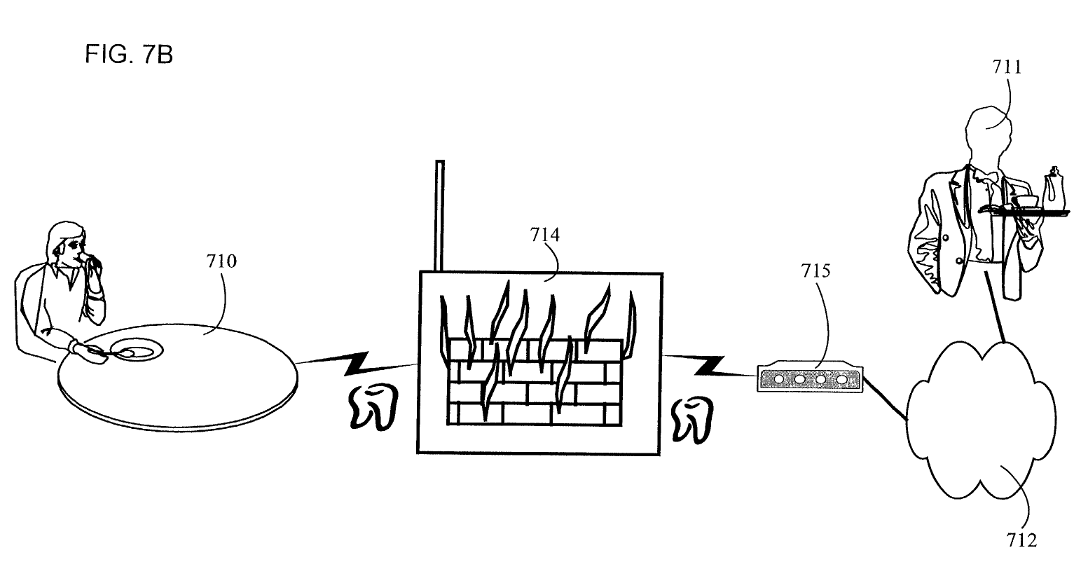

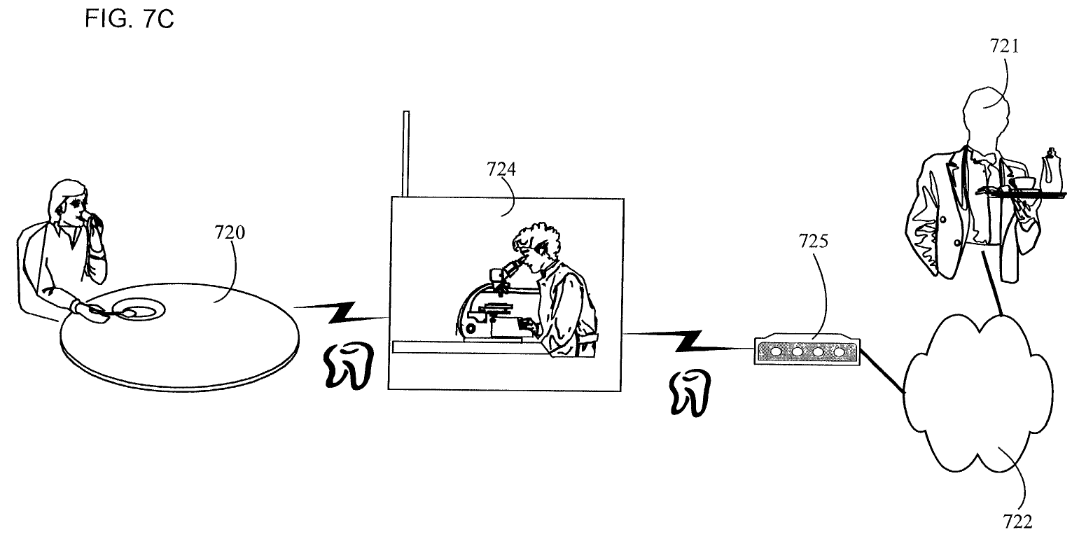

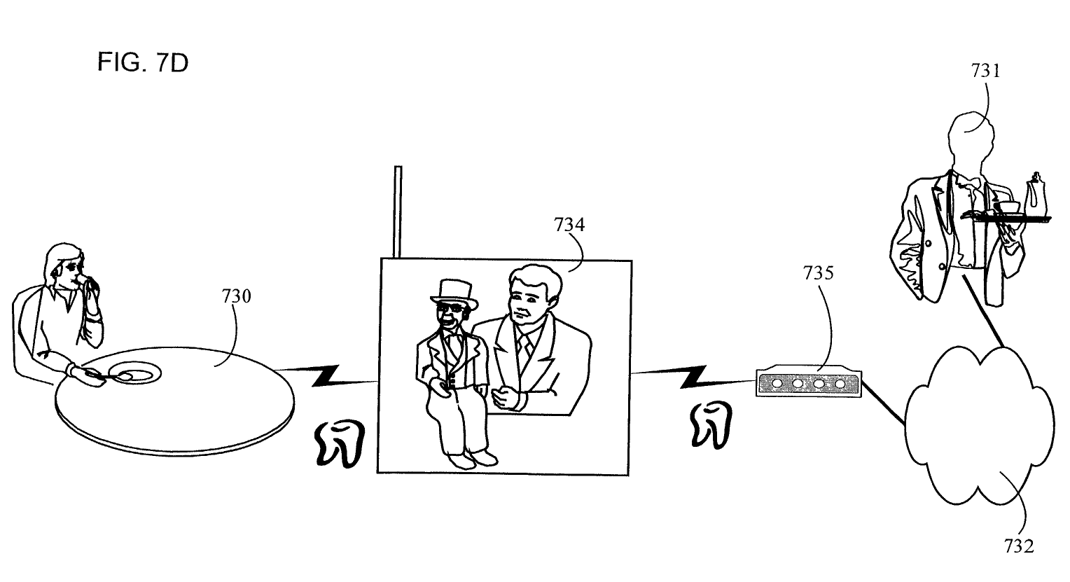

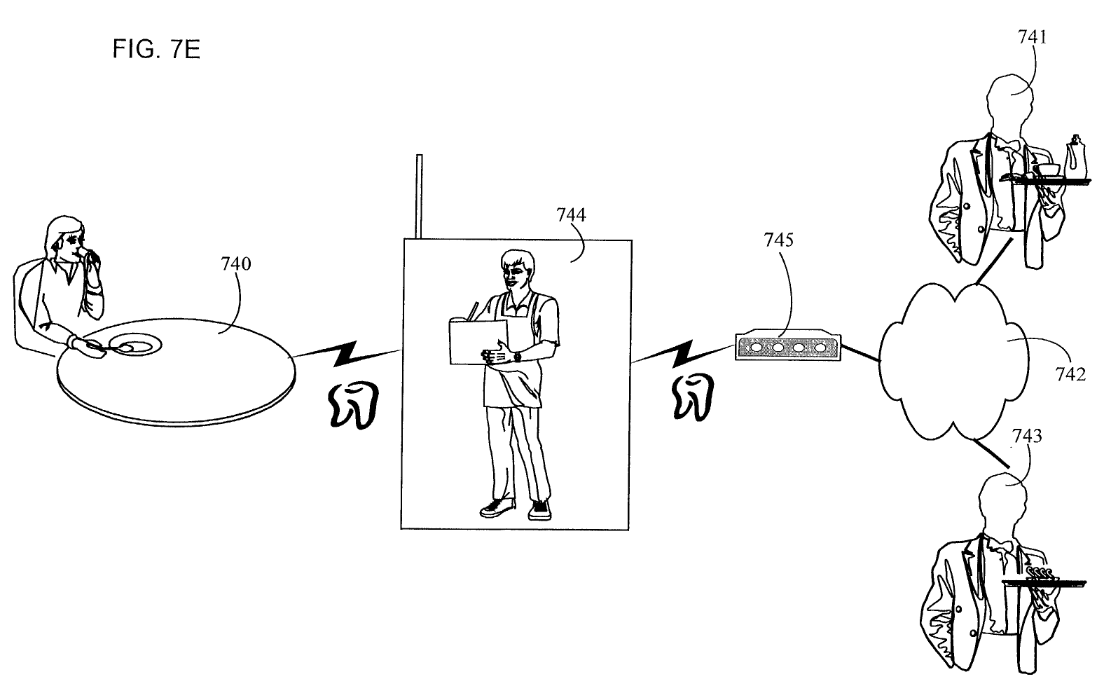

Reference is now made to FIG. 7A is a simplified pictorial illustration of a system and methodology for communication employing a communications quality ameliorator of the type shown in FIG. 3, wherein the communications quality ameliorator provides a communication monitoring functionality.

As seen in FIG. 7A a client, symbolized by a diner at a restaurant and indicated by reference numeral 700, communicates with a server, symbolized by a waiter and indicated by reference numeral 701 via a communications network 702. Communications to and from the client 700 pass via a communications quality ameliorator 704 which has communication monitoring functionality, symbolized by a detective. Preferably BLUETOOTH® communication protocols, symbolized by a tooth is employed for communications between the client 700 and the communications quality ameliorator 704. Communications quality ameliorator 704 communicates with the communication network 702 via an access point 705 preferably at least partially using a BLUETOOTH® communication protocol.

The communication monitoring functionality is any suitable functionality wherein the communications quality ameliorator 704 acts to monitor communications in order to sense and/or analyze information passing through it, without significantly affecting communication content or routing.

Reference is now made to FIG. 7B, which is a simplified pictorial illustration of a system and methodology for communication employing a communications quality ameliorator of the type shown in FIG. 3, wherein the communications quality ameliorator provides a firewall functionality.

As seen in FIG. 7B a client, symbolized by a diner at a restaurant and indicated by reference numeral 710, communicates with a server, symbolized by a waiter and indicated by reference numeral 711 via a communications network 712. Communications to and from the client 710 pass via a communications quality ameliorator 714 which has firewall functionality, symbolized by a fire blocking wall. Preferably BLUETOOTH® communication protocols, symbolized by a tooth is employed for communications between the client 710 and the communications quality ameliorator 714. Communications quality ameliorator 714 communicates with the communication network 712 via an access point 715 preferably at least partially using a BLUETOOTH® communication protocol.

The firewall functionality is any suitable functionality wherein the communications quality ameliorator 714 acts to block unauthorized connections through

Reference is now made to FIG. 7C, which is a simplified pictorial illustration of a system and methodology for communication employing a communications quality ameliorator of the type shown in FIG. 3, wherein the communications quality ameliorator provides a content inspection functionality;

As seen in FIG. 7C a client, symbolized by a diner at a restaurant and indicated by reference numeral 720, communicates with a server, symbolized by a waiter and indicated by reference numeral 721 via a communications network 722. Communications to and from the client 720 pass via a communications quality ameliorator 724 which has content inspection functionality, symbolized by a microscope examination. Preferably BLUETOOTH® communication protocols, symbolized by a tooth is employed for communications between the client 720 and the communications quality ameliorator 724. Communications quality ameliorator 724 communicates with the communication network 722 via an access point 725 preferably at least partially using a BLUETOOTH® communication protocol.

The content inspection functionality is any suitable functionality wherein the communications quality ameliorator 724 acts to combat malicious content passing through it.

Reference is now made to FIG. 7D, which is a simplified pictorial illustration of a system and methodology for communication employing a communications quality ameliorator of the type shown in FIG. 3, wherein the communications quality ameliorator provides a proxy functionality.

As seen in FIG. 7D a client, symbolized by a diner at a restaurant and indicated by reference numeral 730, communicates with a server, symbolized by a waiter and indicated by reference numeral 731 via a communications network 732. Communications to and from the client 730pass via a communications quality ameliorator 734 which has a proxy functionality, symbolized by a ventriloquist. Preferably BLUETOOTH® communication protocols, symbolized by a tooth is employed for communications between the client 730 and the communications quality ameliorator 734. Communications quality ameliorator 734 communicates with the communication network 732 via an access point 735 preferably at least partially using a BLUETOOTH® communication protocol.

The proxy functionality is any suitable functionality wherein the communications quality ameliorator 734 provides an agent which acts on behalf of the client.

Reference is now made to FIG. 7E, which is a simplified pictorial illustration of a system and methodology for communication employing a communications quality ameliorator of the type shown in FIG. 3, wherein the communications quality ameliorator provides a load balancing functionality.

As seen in FIG. 7E a client, symbolized by a diner at a restaurant and indicated by reference numeral 740, communicates with one or more server, symbolized by a drinks waiter and a food waiter and indicated respectively by reference numerals 741 and 743 via a communications network 742. Communications to and from the client 740 pass via a communications quality ameliorator 744 which has a load balancing functionality, symbolized by an order taker. Preferably BLUETOOTH® communication protocols, symbolized by a tooth is employed for communications between the client 740 and the communications quality ameliorator 744. Communications quality ameliorator 744 communicates with the communication network 742 via an access point 745 preferably at least partially using a BLUETOOTH® communication protocol.

It is appreciated that communication between communications quality ameliorator 744 and servers 741 and 743 may employ any combination of the communication methods of the type shown in FIGS. 1-4.

The load balancing functionality is any suitable functionality wherein the communications quality ameliorator 744 directs communications to one of a plurality of servers.

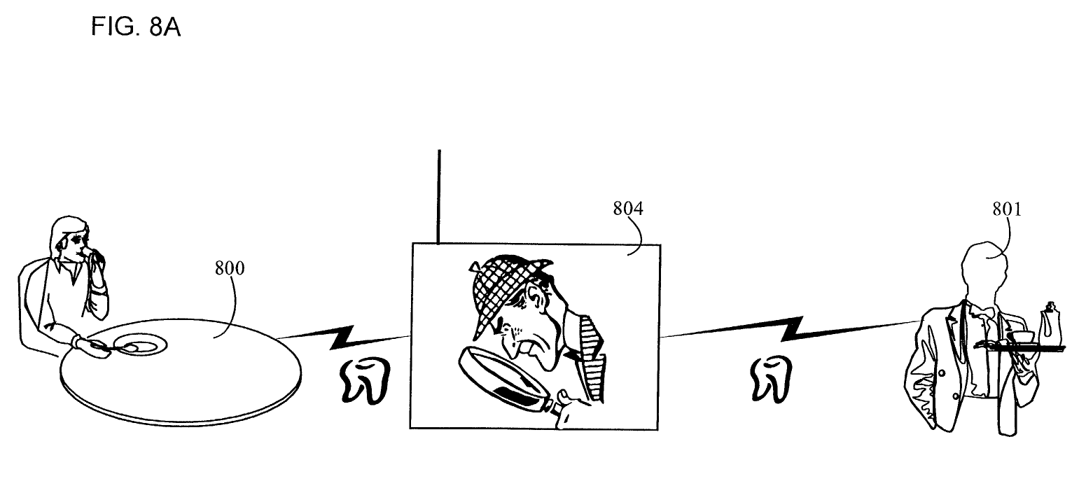

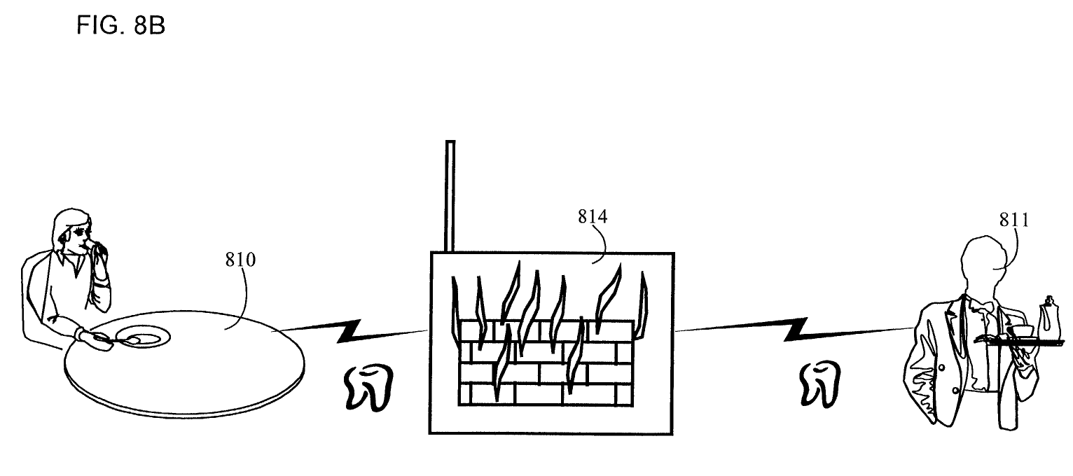

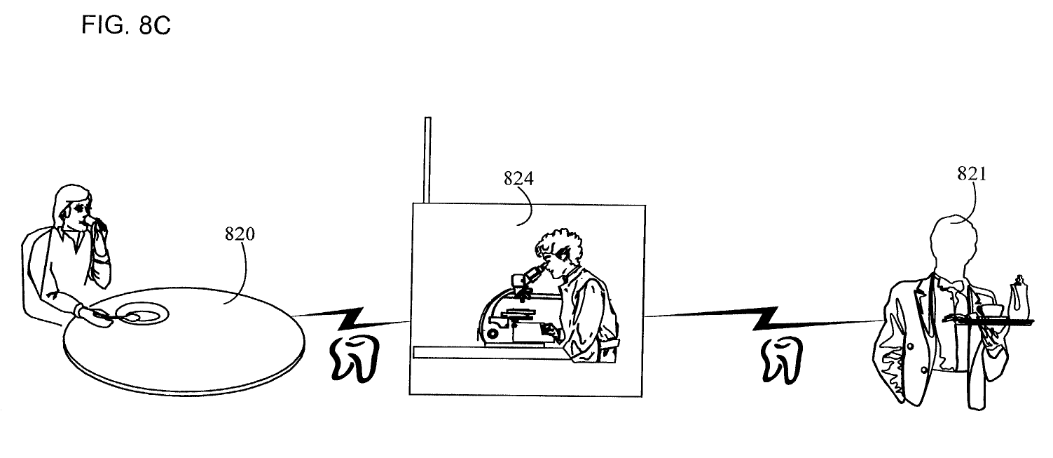

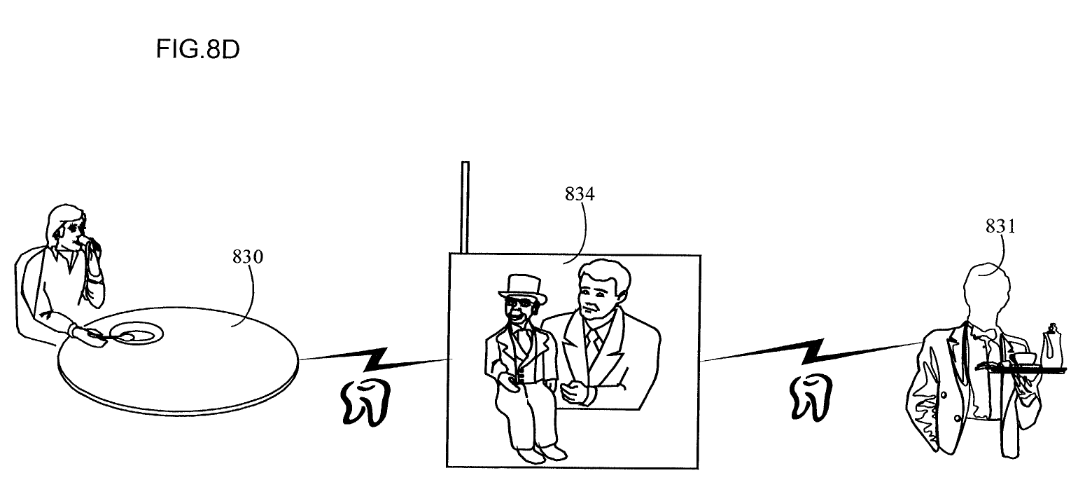

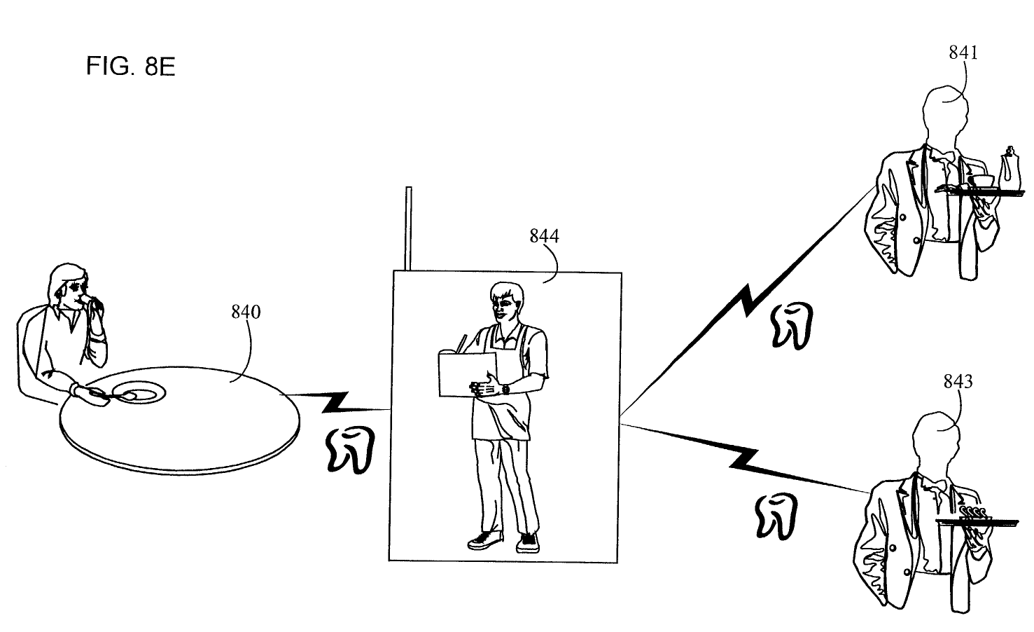

Reference is now made to FIG. 8A is a simplified pictorial illustration of a system and methodology for communication employing a communications quality ameliorator of the type shown in FIG. 4, wherein the communications quality ameliorator provides a communication monitoring functionality.

As seen in FIG. 8A a client, symbolized by a diner at a restaurant and indicated by reference numeral 800, communicates with a server, symbolized by a waiter and indicated by reference numeral 801. Communications to and from the client 800 pass via a communications quality ameliorator 804 which has communication monitoring functionality, symbolized by a detective. Preferably BLUETOOTH® communication protocols, symbolized by a tooth is employed for communications between the client 800 and the communications quality ameliorator 804. Communications quality ameliorator 804 communicates with server 801 at least partially using a BLUETOOTH® communication protocol.

The communication monitoring functionality is any suitable functionality wherein the communications quality ameliorator 804 acts to monitor communications in order to sense and/or analyze information passing through it, without significantly affecting communication content or routing.

Reference is now made to FIG. 8B, which is a simplified pictorial illustration of a system and methodology for communication employing a communications quality ameliorator of the type shown in FIG. 4, wherein the communications quality ameliorator provides a firewall functionality.

As seen in FIG. 8B a client, symbolized by a diner at a restaurant and indicated by reference numeral 810, communicates with a server, symbolized by a waiter and indicated by reference numeral 811. Communications to and from the client 810 pass via a communications quality ameliorator 814 which has firewall functionality, symbolized by a fire blocking wall. Preferably BLUETOOTH® communication protocols, symbolized by a tooth is employed for communications between the client 810 and the communications quality ameliorator 814. Communications quality ameliorator 814 communicates with server 811 at least partially using a BLUETOOTH® communication protocol.

The firewall functionality is any suitable functionality wherein the communications quality ameliorator 814 acts to block unauthorized connections through it.

Reference is now made to FIG. 8C, which is a simplified pictorial illustration of a system and methodology for communication employing a communications quality ameliorator of the type shown in FIG. 4, wherein the communications quality ameliorator provides a content inspection functionality;

As seen in FIG. 8C a client, symbolized by a diner at a restaurant and indicated by reference numeral 820, communicates with a server, symbolized by a waiter and indicated by reference numeral 821. Communications to and from the client 820 pass via a communications quality ameliorator 824 which has content inspection functionality, symbolized by a microscope examination. Preferably BLUETOOTH® communication protocols, symbolized by a tooth is employed for communications between the client 820 and the communications quality ameliorator 824. Communications quality ameliorator 824 communicates with server 821 at least partially using a BLUETOOTH® communication protocol.

The content inspection functionality is any suitable functionality wherein the communications quality ameliorator 824 acts to combat malicious content passing through it.

Reference is now made to FIG. 8D, which is a simplified pictorial illustration of a system and methodology for communication employing a communications quality ameliorator of the type shown in FIG. 4, wherein the communications quality ameliorator provides a proxy functionality.

As seen in FIG. 8D a client, symbolized by a diner at a restaurant and indicated by reference numeral 830, communicates with a server, symbolized by a waiter and indicated by reference numeral 831. Communications to and from the client 830 pass via a communications quality ameliorator 834 which has a proxy functionality, symbolized by a ventriloquist. Preferably BLUETOOTH® communication protocols, symbolized by a tooth is employed for communications between the client 830 and the communications quality ameliorator 834. Communications quality ameliorator 834 communicates with server 831 at least partially using a BLUETOOTH® communication protocol.

The proxy functionality is any suitable functionality wherein the communications quality ameliorator 834 provides an agent which acts on behalf of the client.

Reference is now made to FIG. 8E, which is a simplified pictorial illustration of a system and methodology for communication employing a communications quality ameliorator of the type shown in FIG. 4, wherein the communications quality ameliorator provides a load balancing functionality.

As seen in FIG. 8E a client, symbolized by a diner at a restaurant and indicated by reference numeral 840, communicates with one or more server, symbolized by a drinks waiter and a food waiter and indicated respectively by reference numerals 841 and 843. Communications to and from the client 840 pass via a communications quality ameliorator 844 which has a load balancing functionality, symbolized by an order taker. Preferably BLUETOOTH® communication protocols, symbolized by a tooth is employed for communications between the client 840 and the communications quality ameliorator 844. Communications quality ameliorator 814 communicates with servers 841 and 843 at least partially using a BLUETOOTH® communication protocol.

It is appreciated that communication between communications quality ameliorator 844 and servers 841 and 843 may employ any combination of the communication methods of the type shown in FIGS. 1-4.

The load balancing functionality is any suitable functionality wherein the communications quality ameliorator 844 directs communications to one of a plurality of servers.

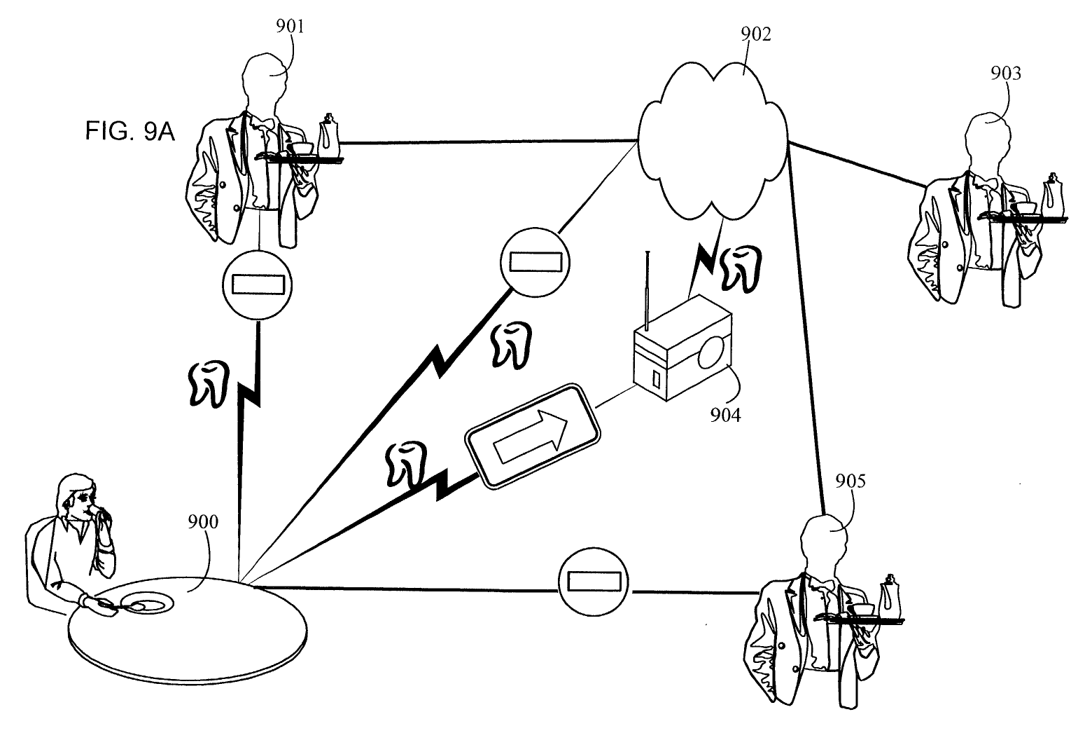

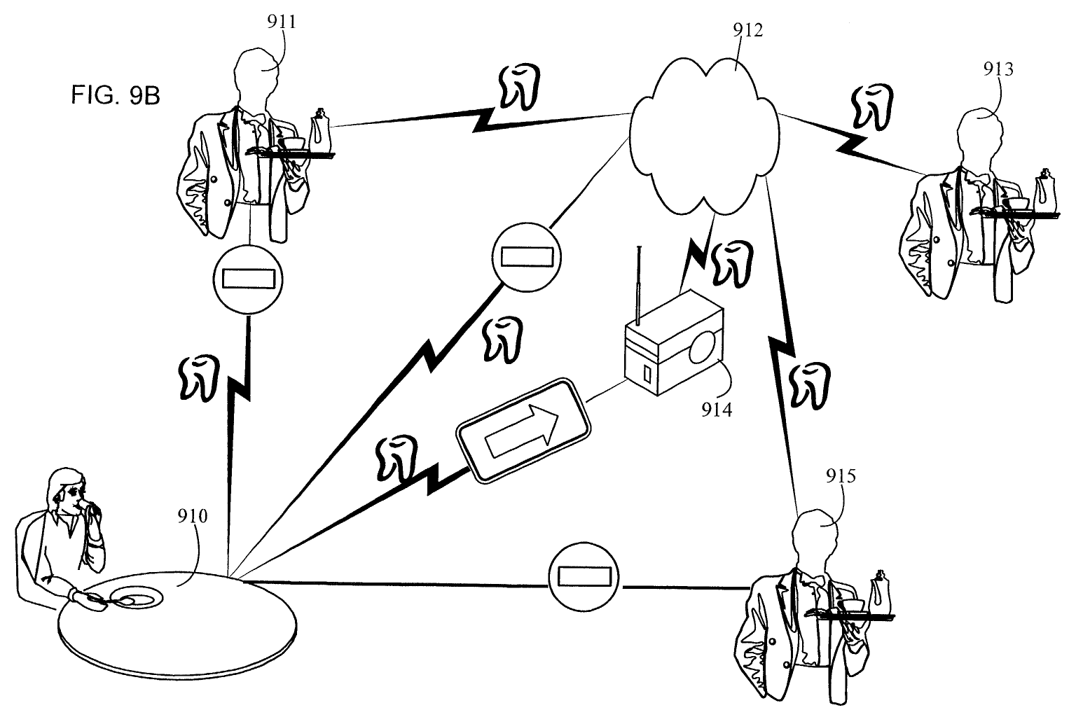

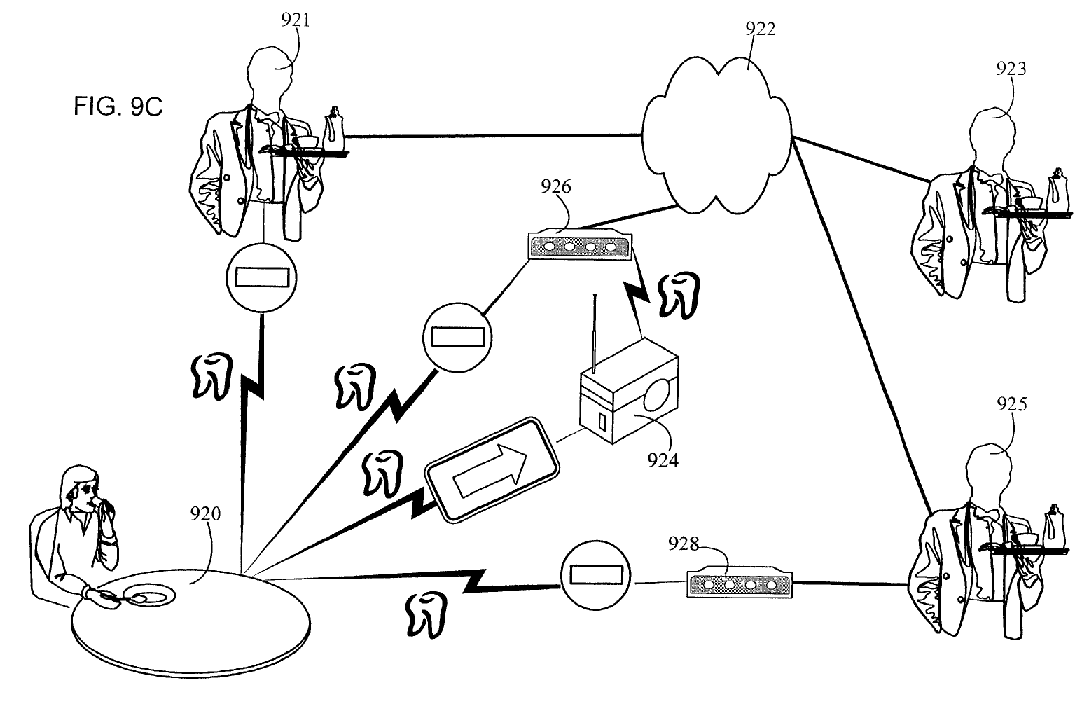

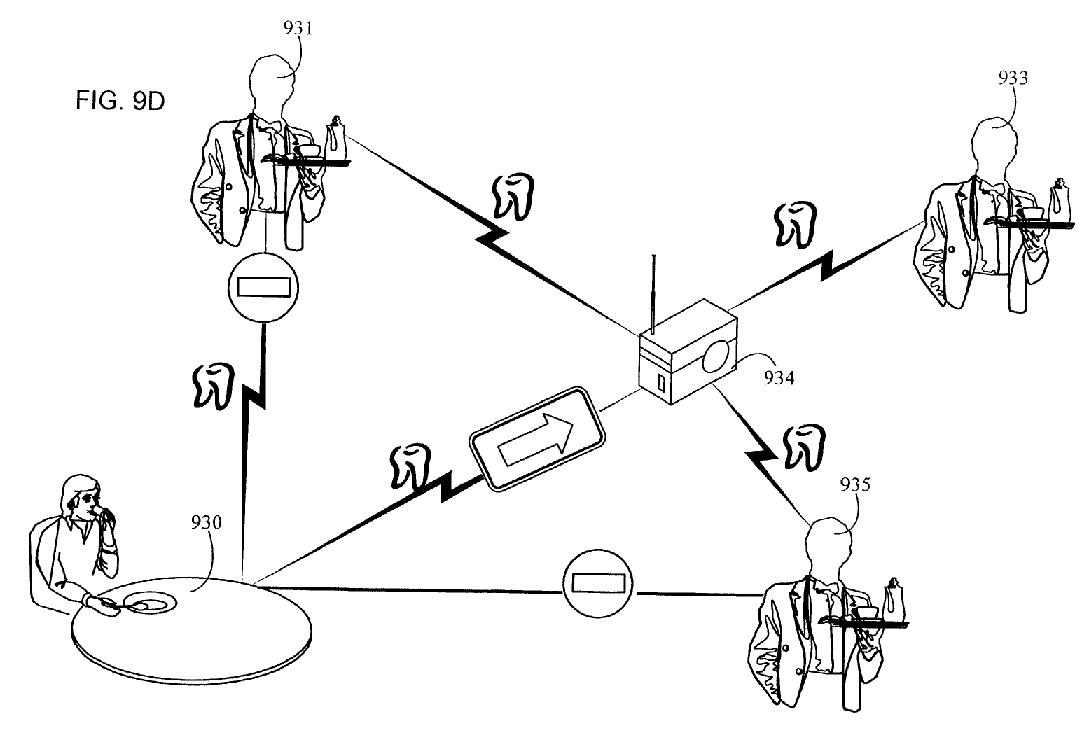

Reference is now made to FIG. 9A, which is a simplified pictorial illustration of a system and methodology for communication employing a communications quality ameliorator and using a BLUETOOTH® communication protocol in accordance with a preferred embodiment of the present invention wherein a device is required to conduct certain communications only via the communications quality ameliorator.

As seen in FIG. 9A in a system, such as the system 100 of FIG. 1, a client symbolized by a diner in a restaurant and indicated by reference numeral 900 is connected by one or more alternative routes to one or more servers, preferably a plurality of servers each symbolized by a waiter and here designated individually by reference numerals 901, 903 and 905.

The servers 901, 903 and 905 are seen to be interconnected by a communication network 902. The client 900 is seen to be connected to communication network 902 both directly using at least partially BLUETOOTH® protocol and via a communications quality ameliorator 904. The communications quality ameliorator 904 communicates with the client 900 using a BLUETOOTH® protocol and also communicates with the communication network 902 using at least partially BLUETOOTH® protocol. The client 900 is seen to be connected to servers 901 and 905 both directly, using at least partially BLUETOOTH® protocol and using any communication protocol respectively and indirectly, via communication network 902.

It is noted that in accordance with a preferred embodiment of the present invention, all communication paths between the client 900 and the servers 901, 903 and 905 as well as the communication network 902, other than via the communications quality ameliorator 904 are not authorized.

Reference is now made to FIG. 9B, which is a simplified pictorial illustration of a system and methodology for communication employing a communications quality ameliorator and using a BLUETOOTH® communication protocol in accordance with a preferred embodiment of the present invention wherein a device is required to conduct certain communications only via the communications quality ameliorator.

As seen in FIG. 9B in a system, such as the system 200 of FIG. 2, a client symbolized by a diner in a restaurant and indicated by reference numeral 910 is connected by one or more alternative routes to one or more servers, preferably a plurality of servers each symbolized by a waiter and here designated individually by reference numerals 911, 913 and 915.

The servers 911, 913 and 915 are seen to be interconnected by a communication network 912 at least partially using BLUETOOTH® protocol. The client 910 is seen to be connected to communication network 912 both directly using at least partially BLUETOOTH® protocol and via a communications quality ameliorator 914. The communications quality ameliorator 914 communicates with the client 910 using a BLUETOOTH® protocol and also communicates with the communication network 912 using at least partially BLUETOOTH® protocol. The client 910 is seen to be connected to servers 911 and 915 both directly, using at least partially BLUETOOTH® protocol and using any communication protocol respectively and indirectly, via communication network 912.

It is noted that in accordance with a preferred embodiment of the present invention, all communication paths between the client 910 and the servers 911, 913 and 915 as well as the communication network 912, other than via the communications quality ameliorator 914 are not authorized.

Reference is now made to FIG. 9C, which is a simplified pictorial illustration of a system and methodology for communication employing a communications quality ameliorator and using a BLUETOOTH® communication protocol in accordance with a preferred embodiment of the present invention wherein a device is required to conduct certain communications only via the communications quality ameliorator.

As seen in FIG. 9C in a system, such as the system 300 of FIG. 3, a client symbolized by a diner in a restaurant and indicated by reference numeral 920 is connected by one or more alternative routes to one or more servers, preferably a plurality of servers each symbolized by a waiter and here designated individually by reference numerals 921, 923 and 925.

The servers 921, 923 and 925 are seen to be interconnected by a communication network 922. The client 920 is seen to be connected to communication network 922 via an access point 926. The client 910 is connected to access point 926 both directly using at least partially BLUETOOTH® protocol and via a communications quality ameliorator 924. The communications quality ameliorator 924 communicates with the client using a BLUETOOTH® protocol and also communicates with the access point 926 using at least partially BLUETOOTH® protocol. The client 920 is seen to be connected to server 921 both directly, using at least partially BLUETOOTH® protocol, and indirectly, via communication network 922. The client 920 is seen to be connected to server 925 both via access point 928 using at least partially BLUETOOTH® protocol and via communication network 922.

It is noted that in accordance with a preferred embodiment of the present invention, all communication paths between the client 920 and the servers 921, 923 and 925 as well as the communication network 922, other than via the communications quality ameliorator 924 are not authorized.

Reference is now made to FIG. 9D, which is a simplified pictorial illustration of a system and methodology for communication employing a communications quality ameliorator and using a BLUETOOTH® communication protocol in accordance with a preferred embodiment of the present invention wherein a device is required to conduct certain communications only via the communications quality ameliorator.

As seen in FIG. 9D in a system, such as the system 400 of FIG. 4, a client symbolized by a diner in a restaurant and indicated by reference numeral 930 is connected by one or more alternative routes to one or more servers, preferably a plurality of servers each symbolized by a waiter and here designated individually by reference numerals 931, 933 and 935.

The client 930 is seen to be connected to server 931 both directly, using at least partially BLUETOOTH® protocol and indirectly via a communications quality ameliorator 934. The communications quality ameliorator 934 communicates with the client using at least partially BLUETOOTH® protocol and also communicates with server 931 using at least partially BLUETOOTH® protocol.

Additionally client 930 is seen to be connected to server 935 both directly, using any suitable communication protocol and indirectly via a communications quality ameliorator 934. The communications quality ameliorator 934 communicates with the client using at least partially BLUETOOTH® protocol and also communicates with server 931 using at least partially BLUETOOTH® protocol.

Additionally client 930 is seen to be connected to server 933 via a communications quality ameliorator 934. The communications quality ameliorator 914 communicates with the client 930 using at least partially BLUETOOTH® protocol and also communicates with server 931 using at least partially BLUETOOTH® protocol.

It is noted that in accordance with a preferred embodiment of the present invention, all communication paths between the client 930 and the servers 931, 933 and 935 as well as the communication network 932, other than via the communications quality ameliorator 934 are not authorized.

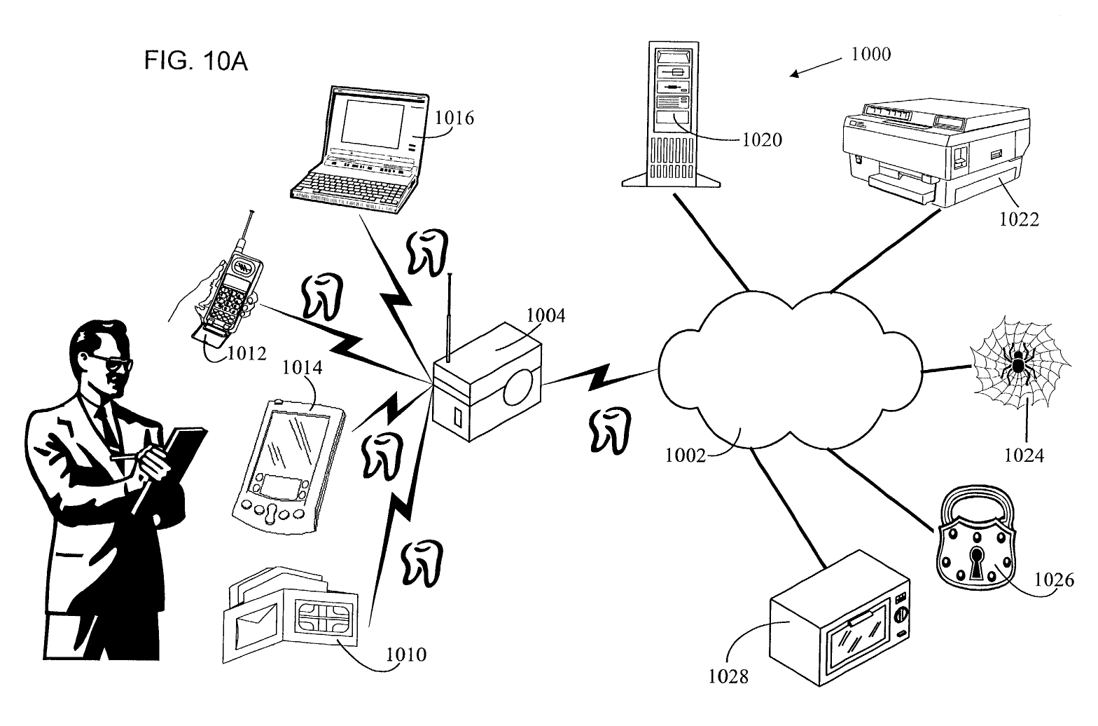

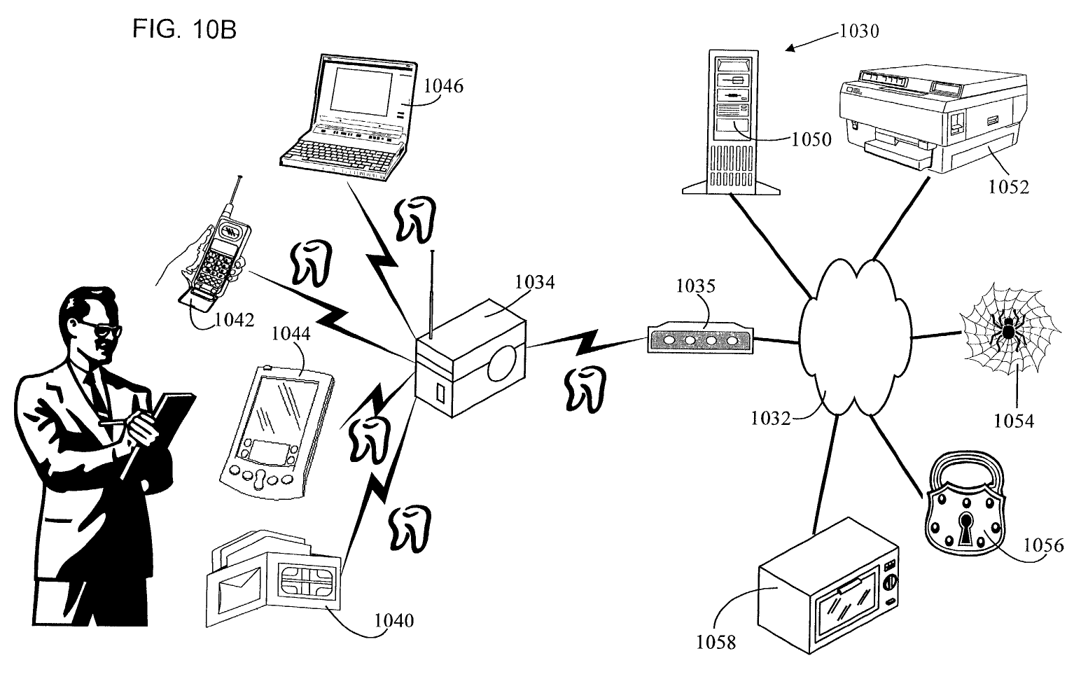

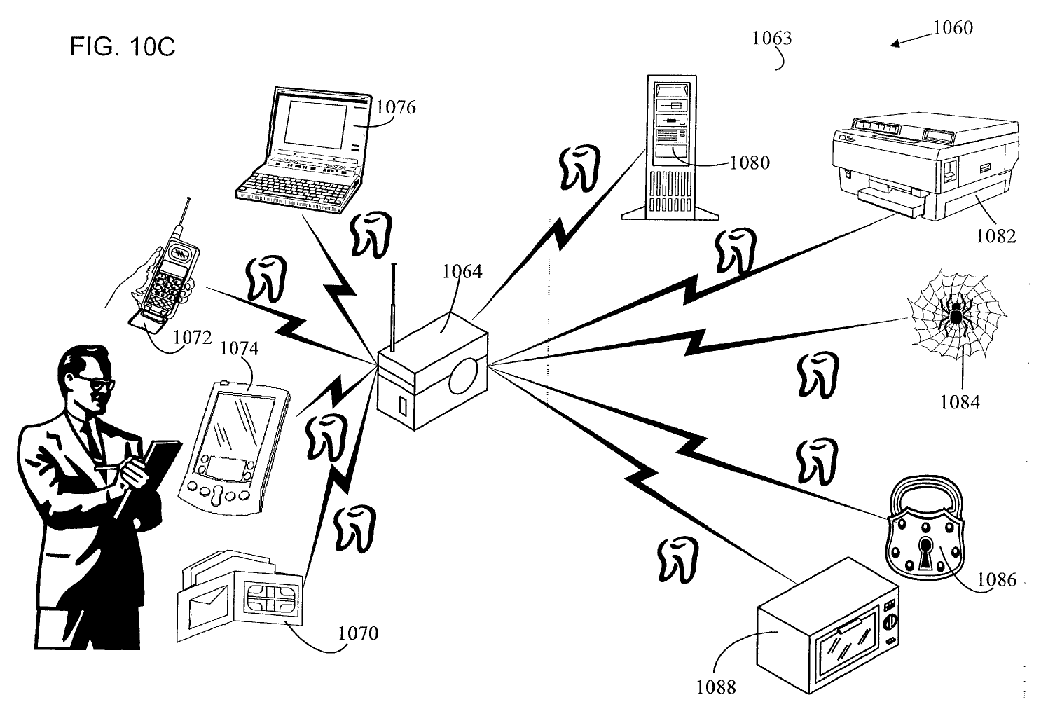

Reference is now made to FIG. 10A, which is a simplified pictorial illustration of a system and methodology for communication employing a portable communications quality ameliorator and using a BLUETOOTH® communication protocol in accordance with a preferred embodiment of the present invention.

As seen in FIG. 10A, there is provided a mobile personal area network (MPAN) 1000 which is suitable for communication with a communication network, such as the Internet, herein designated by reference numeral 1002 or with an intranet. The MPAN 1000 is characterized in that it employs a communications quality ameliorator 1004 which communicates with the communication network at least partially using a BLUETOOTH® communication protocol. The MPAN 1000 is characterized in that it preferably provides communication among and/or for mobile devices used by or accessible to an individual user.

Four different types of devices which are preferably mobile are shown here in BLUETOOTH® communication via communications quality ameliorator 1004 and communication network 1002 with one or more servers. The devices include, for example, an electronic wallet 1010, a telephone 1012, a personal digital assistant 1014 and a notebook PC 1016. In accordance with a preferred embodiment of the present invention the various devices may also communicate among themselves via the communications quality ameliorator 1004.

The servers include, for example, a computer 1020, a printer 1022, a web site 1024, an authenticator 1026 and a microwave oven 1028. It is appreciated that any suitable device or server may alternatively or additionally communicate via communications quality ameliorator 1004 and computer network 1002.

Communications quality ameliorator 1004 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 1016 or personal digital assistant 1014, communicates with communications quality ameliorator 1004 at least partially by using a BLUETOOTH® communication protocol, symbolized by a tooth.

Further in accordance with a preferred embodiment of the present invention, the communications quality ameliorator 1004 communicates with the communication network 1002 at least partially by using a BLUETOOTH® communication protocol, symbolized by a tooth, and thence with one or more servers, such as printer 1022 or web site 1024.

Reference is now made to FIG. 10B, which is a simplified pictorial illustration of a system and methodology for communication employing a portable communications quality ameliorator and using a BLUETOOTH® communication protocol in accordance with another preferred embodiment of the present invention.

As seen in FIG. 10B, there is provided a mobile personal area network (MPAN) 1030 which is suitable for communication with a communication network, such as the Internet, herein designated by reference numeral 1032 or with an intranet. The MPAN 1030 is characterized in that it employs a communications quality ameliorator 1034 which communicates with the communication network 1032 via an access point 1035 preferably at least partially using a BLUETOOTH® communication protocol. The MPAN 1030 is characterized in that it preferably provides communication among and/or for mobile devices used by or accessible to an individual user.

Four different types of devices which are preferably mobile are shown here in BLUETOOTH® communication via communications quality ameliorator 1034 and communication network 1032 with one or more servers. The devices include, for example, an electronic wallet 1040, a telephone 1042, a personal digital assistant 1044 and a notebook PC 1046. In accordance with a preferred embodiment of the present invention the various devices may also communicate among themselves via the communications quality ameliorator 1034.

The servers include, for example, a computer 1050, a printer 1052, a web site 1054, an authenticator 1056 and a microwave oven 1058. It is appreciated that any suitable device or server may alternatively or additionally communicate via communications quality ameliorator 1034 and computer network 1032.

Communications quality ameliorator 1034 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 1046 or personal digital assistant 1044, communicates with communications quality ameliorator 1034 at least partially by using a BLUETOOTH® communication protocol, symbolized by a tooth.

Further in accordance with a preferred embodiment of the present invention, the communications quality ameliorator 1034 communicates, via an access point 1035 with the communication network 1032 at least partially by using a BLUETOOTH® communication protocol, symbolized by a tooth, and thence with one or more server, such as printer 1052 or web site 1054.

Reference is now made to FIG. 10C, which is a simplified pictorial illustration of a system and methodology for communication employing a portable communications quality ameliorator and using a BLUETOOTH® communication protocol in accordance with yet another preferred embodiment of the present invention.

As seen in FIG. 10C, there is provided a mobile personal area network (MPAN) 1060 which is suitable for communication with one or more servers 1063. The MPAN 1060 is characterized in that it employs a communications quality ameliorator 1064 which communicates with the one or more servers 1063 at least partially using a BLUETOOTH® communication protocol. The MPAN 1060 is characterized in that it preferably provides communication among and/or for mobile devices used by or accessible to an individual user.

Four different types of devices which are preferably mobile are shown here in BLUETOOTH® communication via communications quality ameliorator 1064 with one or more servers 1063. The devices include, for example, an electronic wallet 1070, a telephone 1072, a personal digital assistant 1074 and a notebook PC 1076. In accordance with a preferred embodiment of the present invention the various devices may also communicate among themselves via the communications quality ameliorator 1064.

The servers 1063 include, for example, a computer 1080, a printer 1082, a web site 1084, an authenticator 1086 and a microwave oven 1088. It is appreciated that any suitable device or server may alternatively or additionally communicate via communications quality ameliorator 1064.

Communications quality ameliorator 1064 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 1076 or personal digital assistant 1074, communicates with communications quality ameliorator 1064 at least partially by using a BLUETOOTH® communication protocol, symbolized by a tooth.

Further in accordance with a preferred embodiment of the present invention, the communications quality ameliorator 1064 communicates with one or more server, such as printer 1082 or web site 1084 at least partially by using a BLUETOOTH® communication protocol, symbolized by a tooth.

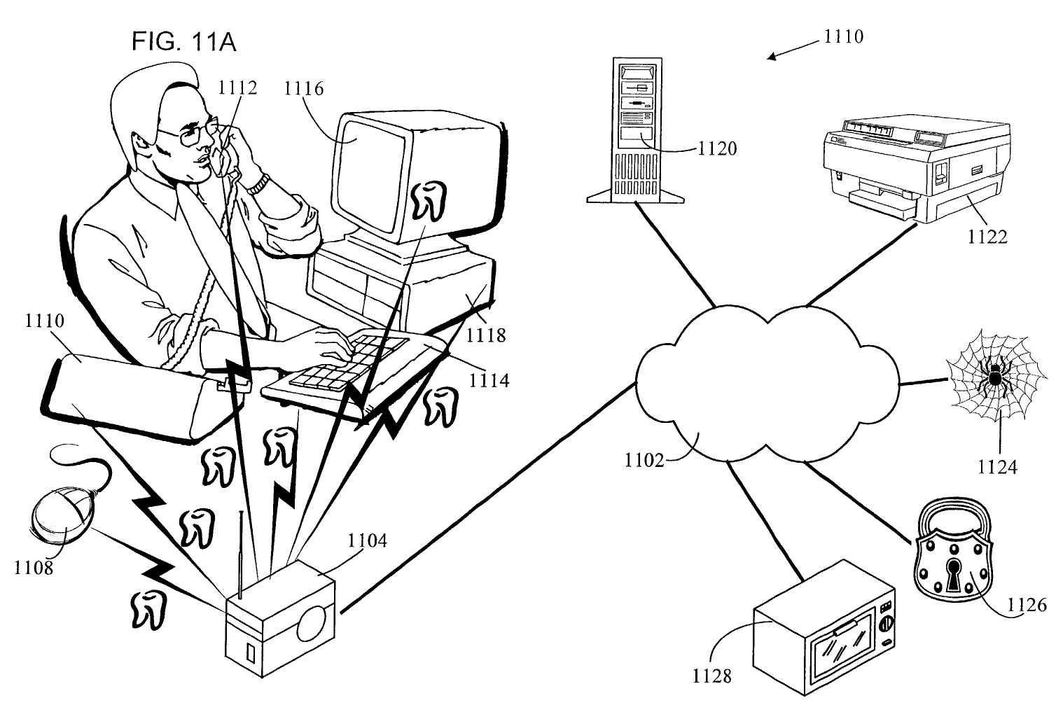

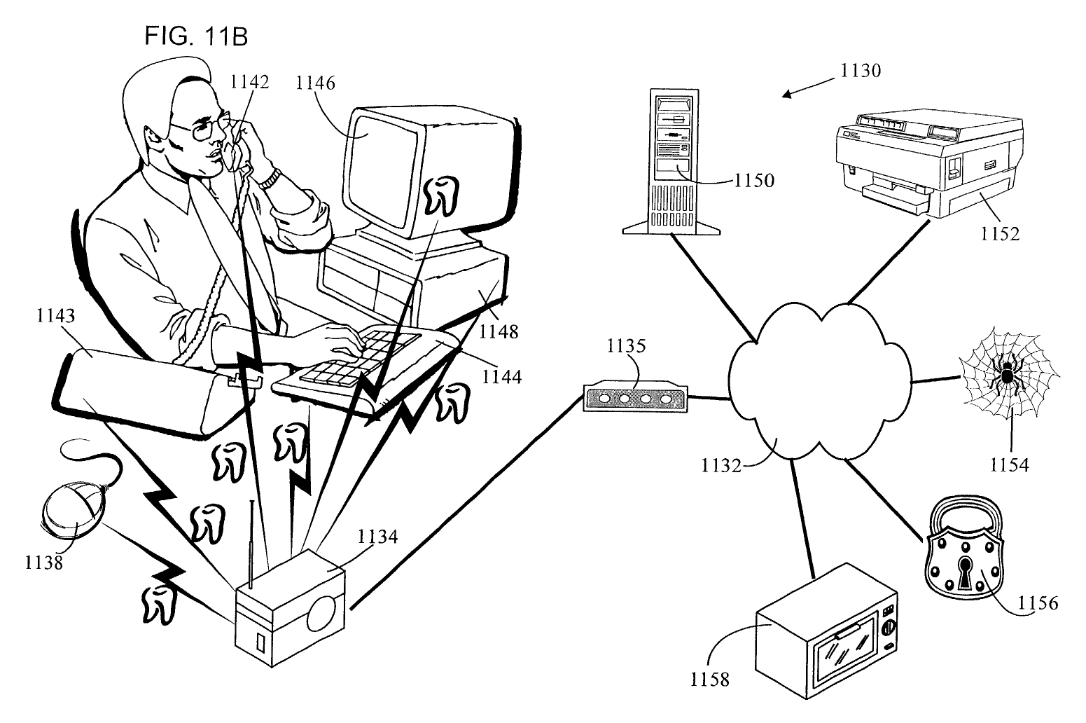

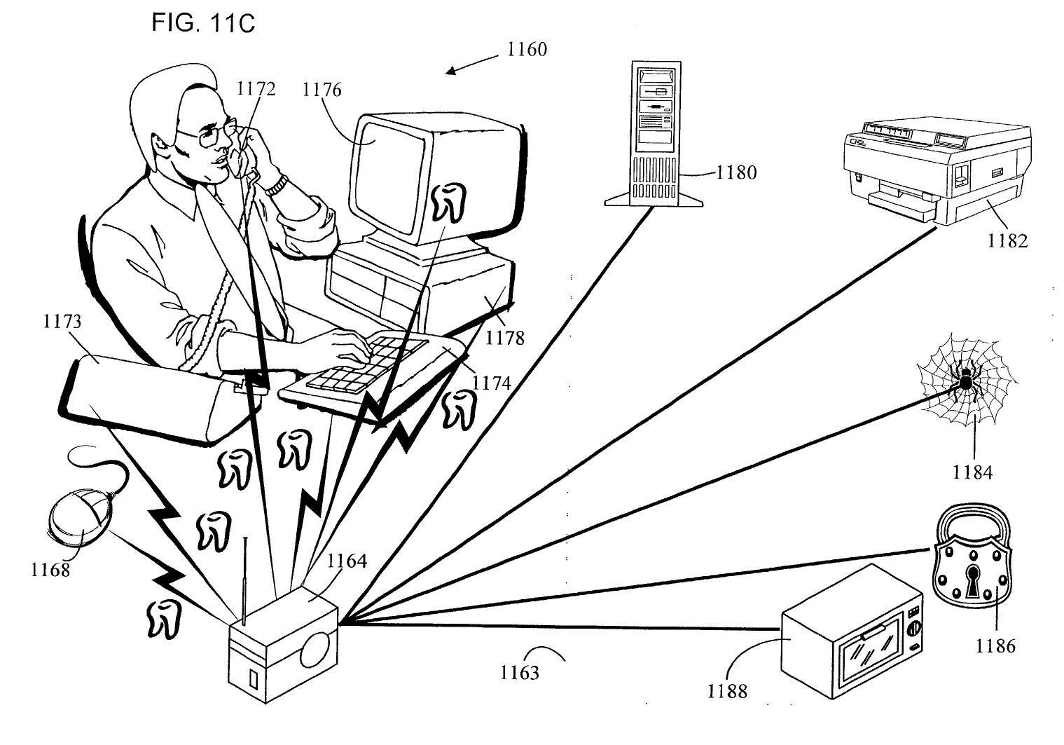

Reference is now made to FIG. 11A, which is a simplified pictorial illustration of a system and methodology for communication employing a stationary communications quality ameliorator and using a BLUETOOTH® communication protocol in accordance with a preferred embodiment of the present invention.

As seen in FIG. 11A, there is provided a stationary personal area network (SPAN) 1100 which is suitable for communication with a communication network, such as the Internet, herein designated by reference numeral 1102 or with an intranet. The SPAN 1100 is characterized in that it employs a communications quality ameliorator 1104 which communicates with the communication network 1102 by any suitable communication protocol. The SPAN 1100 is characterized in that it preferably provides communication among and/or for stationary devices used by or accessible to an individual user within a predetermined region.

Six different types of devices which are preferably stationary are shown here in BLUETOOTH® communication via communications quality ameliorator 1104 and communication network 1102 with one or more servers. The devices include, for example, a mouse 1108, a telephone base unit 1110, a telephone handset 1112, a keyboard 1114, a computer display 1116 and a desktop computer 1118. In accordance with a preferred embodiment of the present invention the various devices may also communicate among themselves via the communications quality ameliorator 1104.

The servers include, for example, a computer 1120, a printer 1122, a web site 1124, an authenticator 1126 and a microwave oven 1128. It is appreciated that any suitable device or server may alternatively or additionally communicate via communications quality ameliorator 1104 and computer network 1102.

Communications quality ameliorator 1104 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as desktop computer 1118 or telephone base unit 1110, communicates with communications quality ameliorator 1104 at least partially by using a BLUETOOTH® communication protocol, symbolized by a tooth.

Further in accordance with a preferred embodiment of the present invention, the communications quality ameliorator 1104 communicates with the communication network 1102 preferably by a stationary connection, and thence with one or more server, such as printer 1122 or web site 1124.

Reference is now made to FIG. 11B, which is a simplified pictorial illustration of a system and methodology for communication employing a stationary communications quality ameliorator and using a BLUETOOTH® communication protocol in accordance with another preferred embodiment of the present invention.

As seen in FIG. 11B, there is provided a stationary personal area network (SPAN) 1130 which is suitable for communication with a communication network, such as the Internet, herein designated by reference numeral 1132 or with an intranet. The SPAN 1130 is characterized in that it employs a communications quality ameliorator 1134 which communicates with the communication network 1132 via an access point 1135 by any suitable communication protocol. The SPAN 1130 is characterized in that it preferably provides communication among and/or for stationary devices used by or accessible to an individual user within a predetermined region.

Six different types of devices which are preferably stationary are shown here in BLUETOOTH® communication via communications quality ameliorator 1134 and communication network 1132 with one or more servers. The devices include, for example, a mouse 1138, a telephone base unit 1143, a telephone handset 1142, a keyboard 1144, a computer display 1146 and a desktop computer 1148. In accordance with a preferred embodiment of the present invention the various devices may also communicate among themselves via the communications quality ameliorator 1134.

The servers include, for example, a computer 1150, a printer 1152, a web site 1154, an authenticator 1156 and a microwave oven 1158. It is appreciated that any suitable device or server may alternatively or additionally communicate via communications quality ameliorator 1134, the access point 1135 and computer network 1132.

Communications quality ameliorator 1134 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as desktop computer 1148 or telephone base unit 1143, communicates with communications quality ameliorator 1134 at least partially by using a BLUETOOTH® communication protocol, symbolized by a tooth.

Further in accordance with a preferred embodiment of the present invention, the communications quality ameliorator 1134 communicates with the communication network 1132 preferably by a stationary connection, and thence with one or more server, such as printer 1152 or web site 1154.

Reference is now made to FIG. 11C, which is a simplified pictorial illustration of a system and methodology for communication employing a stationary communications quality ameliorator and using a BLUETOOTH® communication protocol in accordance with another preferred embodiment of the present invention.

As seen in FIG. 11C, there is provided a stationary personal area network (SPAN) 1160 which is suitable for communication with a one or more servers 1163. The SPAN 1160 is characterized in that it employs a communications quality ameliorator 1164 which communicates with the one or more servers 1163 by any suitable communication protocol. The SPAN 1160 is characterized in that it preferably provides communication among and/or for stationary devices used by or accessible to an individual user within a predetermined region.

Six different types of devices which are preferably stationary are shown here in BLUETOOTH® communication via communications quality ameliorator 1164 with one or more servers 1163. The devices include, for example, a mouse 1168, a telephone base unit 1173, a telephone handset 1172, a keyboard 1174, a computer display 1176 and a desktop computer 1178. In accordance with a preferred embodiment of the present invention the various devices may also communicate among themselves via the communications quality ameliorator 1164.

The servers 1163 include, for example, a computer 1180, a printer 1182, a web site 1184, an authenticator 1186 and a microwave oven 1188. It is appreciated that any suitable device or server may alternatively or additionally communicate via communications quality ameliorator 1164.

Communications quality ameliorator 1164 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as desktop computer 1178 or telephone base unit 1173, communicates with communications quality ameliorator 1164 at least partially by using a BLUETOOTH® communication protocol, symbolized by a tooth.

Further in accordance with a preferred embodiment of the present invention, the communications quality ameliorator 1164 communicates with one or more server 1163, such as printer 1182 or web site 1184 preferably by a stationary connection.

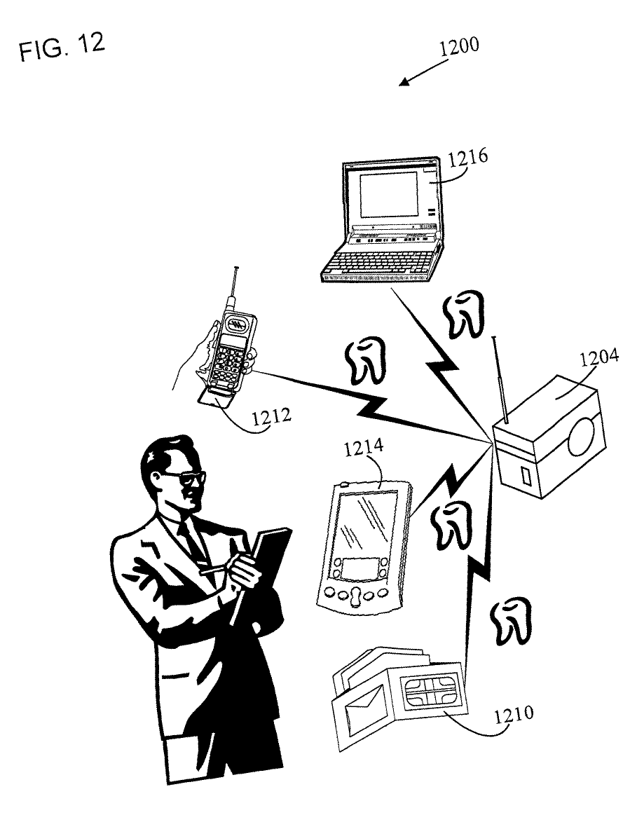

Reference is now made to FIG. 12, which is a simplified pictorial illustration of a system and methodology for communication employing a portable communications quality ameliorator and using a BLUETOOTH® communication protocol in accordance with a preferred embodiment of the present invention.

As seen in FIG. 12, there is provided a mobile personal area network (MPAN) 1200 which is suitable for communication among a number of devices, which are preferably mobile. The MPAN 1200 is characterized in that it employs a communications quality ameliorator 1204 which communicates at least partially using a BLUETOOTH® communication protocol. The MPAN 1200 is characterized in that it preferably provides communication among and/or for mobile devices used by or accessible to an individual user.

Four different types of devices, which are preferably mobile, are shown here in BLUETOOTH® communication via communications quality ameliorator 1204. Some of these devices may operate as servers while others of these devices may operate as clients. The devices include, for example, an electronic wallet 1210, a telephone 1212, a personal digital assistant 1214 and a notebook PC 1216. It is appreciated that any suitable device or server may alternatively or additionally communicate via communications quality ameliorator 1204.

Communications quality ameliorator 1204 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as notebook PC 1216 or personal digital assistant 1214, communicates via communications quality ameliorator 1204 at least partially by using a BLUETOOTH® communication protocol, symbolized by a tooth. For example the personal digital assistant 1214, operating as a client, may communicate at least partially by using a BLUETOOTH® communication protocol, via communications quality ameliorator 1204 with the notebook PC 1216, operating as a server.

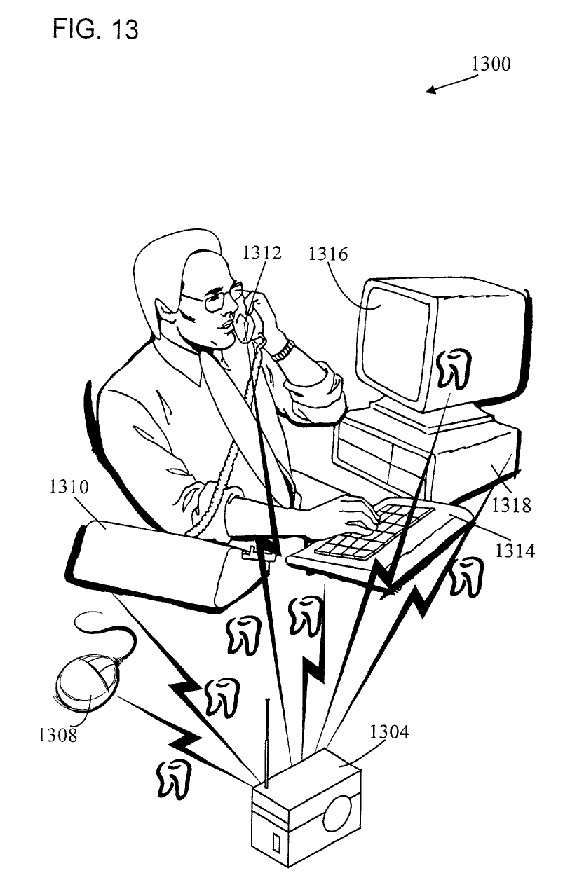

Reference is now made to FIG. 13, which is a simplified pictorial illustration of a system and methodology for communication employing a stationary communications quality ameliorator and using a BLUETOOTH® communication protocol in accordance with a preferred embodiment of the present invention.

As seen in FIG. 13, there is provided a stationary personal area network (SPAN) 1300 which is suitable for communication with a communication network, such as the Internet, herein designated by reference numeral 1302 or with an intranet. The SPAN 1300 is characterized in that it employs a communications quality ameliorator 1304 which communicates at least partially using a BLUETOOTH® communication protocol. The SPAN 1300 is characterized in that it preferably provides communication among and/or for stationary devices used by or accessible to an individual user within a predetermined region.

Six different types of devices which are preferably stationary are shown here in BLUETOOTH® communication via communications quality ameliorator 1304. Some of these devices may operate as servers while others of these devices may operate as clients. The devices include, for example, a mouse 1308, a telephone base unit 1310, a telephone handset 1312, a keyboard 1314, a computer display 1316 and a desktop computer 1318. In accordance with a preferred embodiment of the present invention the various devices may also communicate among themselves via the communications quality ameliorator 1304.

Communications quality ameliorator 1304 is preferably characterized in that it provides one or more of the following functionalities:

a communication monitoring functionality;

an accounting functionality;

a billing functionality;

a firewall functionality;

a content inspection functionality;

a proxy functionality;

a caching functionality;

a quality of service functionality;

an encryption functionality;

an authentication functionality; and

a load balancing functionality.

In accordance with one embodiment of the present invention, at least one device, such as telephone handset 1312 or telephone base unit 1310, communicates via communications quality ameliorator 1304 at least partially by using a BLUETOOTH® communication protocol, symbolized by a tooth. For example the telephone handset 1312, operating as a client, may communicate at least partially by using a BLUETOOTH® communication protocol, via communications quality ameliorator 1204 with the telephone base unit 1304, operating as a server.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A system for use in a communication network and comprising:
at least one first device;
at least one second device; and
a communication quality ameliorator including:
a first interface providing first interaction with said at least one first device; and
a second interface providing second interaction with said at least one second device, said second interaction including at least BLUETOOTH® communication.

2. A system according to claim 1 and wherein said communication quality ameliorator provides a communication security functionality.

3. A system according to claim 1 and wherein said communication quality ameliorator provides a firewall functionality.

4. A system according to claim 1 and wherein said communication quality ameliorator provides a content inspection functionality.

5. A system according to claim 1 and wherein said communication quality ameliorator provides an authentication functionality.

6. A system according to claim 1 and wherein said communication quality ameliorator provides a communication performance amelioration functionality.

7. A system according to claim 1 and wherein said communication quality ameliorator provides a proxy functionality.

8. A system according to claim 1 and wherein said communication quality ameliorator provides a communication monitoring functionality.

9. A system according to claim 1 and wherein said communication quality ameliorator provides a load balancing functionality.

10. A system according to claim 1 and wherein said communication quality ameliorator provides a caching functionality.

11. A system according to claim 1 and wherein said communication quality ameliorator provides a quality of service functionality.

12. A system according to claim 1 and wherein said communication quality ameliorator provides a communication availability functionality.

13. A system according to claim 1 and wherein said communication quality ameliorator provides a communication accountability functionality.

14. A system according to claim 1 and wherein said communication quality ameliorator provides an accounting functionality.

15. A system according to claim 1 and wherein said communication quality ameliorator provides a billing functionality:

16. A system according to claim 1 and wherein said communications quality ameliorator is portable.

17. A system according to claim 16 and wherein said communication quality ameliorator provides a communication security functionality.

18. A system according to claim 16 and wherein said communication quality ameliorator provides a communication performance amelioration functionality.

19. A system according to claim 16 and wherein said communication quality ameliorator provides a communication availability functionality.

20. A system according to claim 16 and wherein said communication quality ameliorator provides a communication accountability functionality.

21. A system according to claim 16 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

24. A system according to claim 1 and wherein said communications quality ameliorator is stationary.

25. A system according to claim 24 and wherein said communication quality ameliorator provides a communication security functionality.

26. A system according to claim 24 and wherein said communication quality ameliorator provides a communication performance amelioration functionality.

27. A system according to claim 24 and wherein said communication quality ameliorator provides a communication availability functionality.

28. A system according to claim 24 and wherein said communication quality ameliorator provides a communication accountability functionality.

29. A system according to claim 24 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

30. A system according to claim 1 and wherein said second interaction comprises at least principally of BLUETOOTH® communication.

31. A system according to claim 30 and wherein said communication quality ameliorator provides a communication security functionality.

32. A system according to claim 30 and wherein said communication quality ameliorator provides a communication performance amelioration functionality.

33. A system according to claim 30 and wherein said communication quality ameliorator provides a communication availability functionality.

34. A system according to claim 30 and wherein said communication quality ameliorator provides a communication accountability functionality.

35. A system according to claim 30 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

36. A system according to claim 30 and wherein said communications quality ameliorator is portable.

37. A system according to claim 36 and wherein said communication quality ameliorator provides a communication security functionality.

38. A system according to claim 36 and wherein said communication quality ameliorator provides a communication performance amelioration functionality.

39. A system according to claim 36 and wherein said communication quality ameliorator provides a communication availability functionality.

40. A system according to claim 36 and wherein said communication quality ameliorator provides a communication accountability functionality.

41. A system according to claim 36 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

44. A system according to claim 30 and wherein said communications quality ameliorator is stationary.

45. A system according to claim 44 and wherein said communication quality ameliorator provides a communication security functionality.

46. A system according to claim 44 and wherein said communication quality ameliorator provides a communication performance amelioration functionality.

47. A system according to claim 44 and wherein said communication quality ameliorator provides a communication availability functionality.

48. A system according to claim 44 and wherein said communication quality ameliorator provides a communication accountability functionality.

49. A system according to claim 44 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

50. A system according to claim 1 and wherein said first interaction includes at least some non-BLUETOOTH® communication.

51. A system according to claim 50 and wherein said communication quality ameliorator provides a communication security functionality.

52. A system according to claim 50 and wherein said communication quality ameliorator provides a communication performance amelioration functionality.

53. A system according to claim 50 and wherein said communication quality ameliorator provides a communication availability functionality.

54. A system according to claim 50 and wherein said communication quality ameliorator provides a communication accountability functionality.

55. A system according to claim 50 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

56. A system according to claim 50 and wherein said communications quality ameliorator is portable.

57. A system according to claim 56 and wherein said communication quality ameliorator provides at least one of the following functionalities:
a communication security functionality;
a performance amelioration functionality;
a communication availability functionality; and
a communication accountability functionality.

58. A system according to claim 56 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

59. A system according to claim 50 and wherein said communications quality ameliorator is stationary.

60. A system according to claim 59 and wherein said communication quality ameliorator provides at least one of the following functionalities:
a communication security functionality;
a performance amelioration functionality;
a communication availability functionality; and
a communication accountability functionality.

61. A system according to claim 59 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

62. A system according to claim 50 wherein said second interaction comprises at least principally of BLUETOOTH® communication.

63. A system according to claim 62 and wherein said communication quality ameliorator provides at least one of the following functionalities:
a communication security functionality;
a performance amelioration functionality;
a communication availability functionality; and
a communication accountability functionality.

64. A system according to claim 62 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

65. A system according to claim 1 and wherein said first interaction comprises at least principally of BLUETOOTH® communication with an access point.

66. A system according to claim 65 and wherein said communication quality ameliorator provides at least one of the following functionalities:
a communication security functionality;
a performance amelioration functionality;
a communication availability functionality; and
a communication accountability functionality.

67. A system according to claim 65 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

68. A system according to claim 65 and wherein said communications quality ameliorator is portable.

69. A system according to claim 68 and wherein said communication quality ameliorator provides at least one of the following functionalities:
a communication security functionality;
a performance amelioration functionality;
a communication availability functionality; and
a communication accountability functionality.

70. A system according to claim 68 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

71. A system according to claim 65 and wherein said communications quality ameliorator is stationary.

72. A system according to claim 71 and wherein said communication quality ameliorator provides at least one of the following functionalities:
a communication security functionality;
a performance amelioration functionality;
a communication availability functionality; and
a communication accountability functionality.

73. A system according to claim 71 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

74. A system according to claim 65 and wherein said second interaction comprises at least principally of BLUETOOTH® communication.

75. A system according to claim 74 and wherein said communication quality ameliorator provides at least one of the following functionalities:
a communication security functionality;
a performance amelioration functionality;
a communication availability functionality; and
a communication accountability functionality.

76. A system according to claim 74 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

77. A system according to claim 65 and wherein said first interaction includes at least some non-BLUETOOTH® communication between said access point and said at least one first device.

78. A system according to claim 1 and wherein both said first and second interactions comprise at least principally of BLUETOOTH® communication.

79. A system according to claim 78 and wherein said communication quality ameliorator provides a communication security functionality.

80. A system according to claim 78 and wherein said communication quality ameliorator provides a communication performance amelioration functionality.

81. A system according to claim 78 and wherein said communication quality ameliorator provides a communication availability functionality.

82. A system according to claim 78 and wherein said communication quality ameliorator provides a communication accountability functionality.

83. A system according to claim 78 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

84. A system according to claim 78 and wherein said communications quality ameliorator is portable.

85. A system according to claim 84 and wherein said communication quality ameliorator provides a communication security functionality.

86. A system according to claim 84 and wherein said communication quality ameliorator provides a communication performance amelioration functionality.

87. A system according to claim 84 and wherein said communication quality ameliorator provides a communication availability functionality.

88. A system according to claim 84 and wherein said communication quality ameliorator provides a communication accountability functionality.

89. A system according to claim 84 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

92. A system according to claim 78 and wherein said communications quality ameliorator is stationary.

93. A system according to claim 92 and wherein said communication quality ameliorator provides a communication security functionality.

94. A system according to claim 92 and wherein said communication quality ameliorator provides a communication performance amelioration functionality.

95. A system according to claim 92 and wherein said communication quality ameliorator provides a communication availability functionality.

96. A system according to claim 92 and wherein said communication quality ameliorator provides a communication accountability functionality.

97. A system according to claim 92 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

98. A system according to claim 1 and wherein both said at least one first device comprises a server.

99. A system according to claim 98 and wherein said communication quality ameliorator provides at least one of the following functionalities:
a communication security functionality;
a performance amelioration functionality;
a communication availability functionality; and
a communication accountability functionality.

100. A system according to claim 98 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

101. A system according to claim 98 and wherein said communications quality ameliorator is portable.

102. A system according to claim 101 and wherein said communication quality ameliorator provides at least one of the following functionalities:
a communication security functionality;
a performance amelioration functionality;
a communication availability functionality; and
a communication accountability functionality.

103. A system according to claim 101 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

104. A system according to claim 98 and wherein said communications quality ameliorator is stationary.

105. A system according to claim 104 and wherein said communication quality ameliorator provides at least one of the following functionalities:
a communication security functionality;
a performance amelioration functionality;
a communication availability functionality; and
a communication accountability functionality.

106. A system according to claim 104 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

107. A system according to claim 98 and wherein said second interaction comprises at least principally of BLUETOOTH® communication.

108. A system according to claim 107 and wherein said communication quality ameliorator provides at least one of the following functionalities:
a communication security functionality;
a performance amelioration functionality;
a communication availability functionality; and
a communication accountability functionality.

109. A system according to claim 107 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

110. A system according to claim 98 and wherein said first interaction includes at least some non-BLUETOOTH® communication between said access point and said at least one first device.

111. A system according to claim 98 and wherein said at least one first device comprises a plurality of first devices.

112. A system according to claim 1 and wherein said at least one first device comprises at least one of:
a printer;
a web site;
a computer;
a computer screen;
a cordless telephone base unit;
an authenticator; and
a domestic appliance.

113. A system according to claim 1 and wherein both said at least one second device comprises a client.

114. A system according to claim 113 and wherein said communication quality ameliorator provides at least one of the following functionalities:
a communication security functionality;
a performance amelioration functionality;
a communication availability functionality; and
a communication accountability functionality.

115. A system according to claim 113 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

116. A system according to claim 113 and wherein said communications quality ameliorator is portable.

117. A system according to claim 116 and wherein said communication quality ameliorator provides at least one of the following functionalities:
a communication security functionality;
a performance amelioration functionality;
a communication availability functionality; and
a communication accountability functionality.

118. A system according to claim 116 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

119. A system according to claim 113 and wherein said communications quality ameliorator is stationary.

120. A system according to claim 119 and wherein said communication quality ameliorator provides at least one of the following functionalities:
a communication security functionality;
a performance amelioration functionality;
a communication availability functionality; and
a communication accountability functionality.

121. A system according to claim 119 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

122. A system according to claim 113 and wherein said second interaction comprises at least principally of BLUETOOTH® communication.

123. A system according to claim 122 and wherein said communication quality ameliorator provides at least one of the following functionalities:
a communication security functionality;
a performance amelioration functionality;
a communication availability functionality; and
a communication accountability functionality.

124. A system according to claim 122 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

125. A system according to claim 113 and wherein said first interaction includes at least some non-BLUETOOTH® communication between said access point and said at least one first device.

126. A system according to claim 113 and wherein said at least one second device comprises a plurality of second devices.

127. A system according to claim 1 and wherein said at least one second device comprises at least one of:
an electronic wallet;
a telephone;
a cordless telephone handset
a personal digital assistant;
a portable computer;
a keyboard;
a mouse; and
a remote controller.

128. A system for use in a communication network and comprising:
at least one first device;
at least one second device; and
a communications quality ameliorator including:
a first interface providing interaction with said at least one first device; and
a second interface providing interaction with said at least one second device, said second device being required to conduct certain communications only via said communications quality ameliorator, said interaction including at least BLUETOOTH® communication.

129. A system according to claim 128 and wherein said communication quality ameliorator provides a communication security functionality.

130. A system according to claim 128 and wherein said communication quality ameliorator provides a firewall functionality.

131. A system according to claim 128 and wherein said communication quality ameliorator provides a content inspection functionality.

132. A system according to claim 128 and wherein said communication quality ameliorator provides an authentication functionality.

133. A system according to claim 128 and wherein said communication quality ameliorator provides a communication performance amelioration functionality.

134. A system according to claim 128 and wherein said communication quality ameliorator provides a proxy functionality.

135. A system according to claim 128 and wherein said communication quality ameliorator provides a communication monitoring functionality.

136. A system according to claim 128 and wherein said communication quality ameliorator provides a load balancing functionality.

137. A system according to claim 128 and wherein said communication quality ameliorator provides a caching functionality.

138. A system according to claim 128 and wherein said communication quality ameliorator provides a quality of service functionality.

139. A system according to claim 128 and wherein said communication quality ameliorator provides a communication availability functionality.

140. A system according to claim 128 and wherein said communication quality ameliorator provides a communication accountability functionality.

141. A system according to claim 128 and wherein said communication quality ameliorator provides an accounting functionality.

142. A system according to claim 128 and wherein said communication quality ameliorator provides a billing functionality:

143. A system according to claim 128 and wherein said communications quality ameliorator is portable.

144. A system according to claim 143 and wherein said communication quality ameliorator provides a communication security functionality.

145. A system according to claim 143 and wherein said communication quality ameliorator provides a communication performance amelioration functionality.

146. A system according to claim 143 and wherein said communication quality ameliorator provides a communication availability functionality.

147. A system according to claim 143 and wherein said communication quality ameliorator provides a communication accountability functionality.

148. A system according to claim 143 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

151. A system according to claim 128 and wherein said communications quality ameliorator is stationary.

152. A system according to claim 151 and wherein said communication quality ameliorator provides a communication security functionality.

153. A system according to claim 151 and wherein said communication quality ameliorator provides a communication performance amelioration functionality.

154. A system according to claim 151 and wherein said communication quality ameliorator provides a communication availability functionality.

155. A system according to claim 151 and wherein said communication quality ameliorator provides a communication accountability functionality.

156. A system according to claim 151 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

157. A system according to claim 128 and wherein said second interaction comprises at least principally of BLUETOOTH® communication.

158. A system according to claim 157 and wherein said communication quality ameliorator provides a communication security functionality.

159. A system according to claim 157 and wherein said communication quality ameliorator provides a communication performance amelioration functionality.

160. A system according to claim 157 and wherein said communication quality ameliorator provides a communication availability functionality.

161. A system according to claim 157 and wherein said communication quality ameliorator provides a communication accountability functionality.

162. A system according to claim 157 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

163. A system according to claim 157 and wherein said communications quality ameliorator is portable.

164. A system according to claim 163 and wherein said communication quality ameliorator provides a communication security functionality.

165. A system according to claim 163 and wherein said communication quality ameliorator provides a communication performance amelioration functionality.

166. A system according to claim 163 and wherein said communication quality ameliorator provides a communication availability functionality.

167. A system according to claim 163 and wherein said communication quality ameliorator provides a communication accountability functionality.

168. A system according to claim 163 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

171. A system according to claim 157 and wherein said communications quality ameliorator is stationary.

172. A system according to claim 171 and wherein said communication quality ameliorator provides a communication security functionality.

173. A system according to claim 171 and wherein said communication quality ameliorator provides a communication performance amelioration functionality.

174. A system according to claim 171 and wherein said communication quality ameliorator provides a communication availability functionality.

175. A system according to claim 171 and wherein said communication quality ameliorator provides a communication accountability functionality.

176. A system according to claim 171 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

177. A system according to claim 128 and wherein said first interaction includes at least some non-BLUETOOTH® communication.

178. A system according to claim 177 and wherein said communication quality ameliorator provides a communication security functionality.

179. A system according to claim 177 and wherein said communication quality ameliorator provides a communication performance amelioration functionality.

180. A system according to claim 177 and wherein said communication quality ameliorator provides a communication availability functionality.

181. A system according to claim 177 and wherein said communication quality ameliorator provides a communication accountability functionality.

182. A system according to claim 177 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

183. A system according to claim 177 and wherein said communications quality ameliorator is portable.

184. A system according to claim 183 and wherein said communication quality ameliorator provides at least one of the following functionalities:
a communication security functionality;
a performance amelioration functionality;
a communication availability functionality; and
a communication accountability functionality.

185. A system according to claim 183 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

186. A system according to claim 177 and wherein said communications quality ameliorator is stationary.

187. A system according to claim 186 and wherein said communication quality ameliorator provides at least one of the following functionalities:
a communication security functionality;
a performance amelioration functionality;
a communication availability functionality; and
a communication accountability functionality.

188. A system according to claim 186 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

189. A system according to claim 177 wherein said second interaction comprises at least principally of BLUETOOTH® communication.

190. A system according to claim 189 and wherein said communication quality ameliorator provides at least one of the following functionalities:
a communication security functionality;
a performance amelioration functionality;
a communication availability functionality; and
a communication accountability functionality.

191. A system according to claim 189 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

192. A system according to claim 128 and wherein said first interaction comprises at least principally of BLUETOOTH® communication with an access point.

193. A system according to claim 192 and wherein said communication quality ameliorator provides at least one of the following functionalities:
a communication security functionality;
a performance amelioration functionality;
a communication availability functionality; and
a communication accountability functionality.

194. A system according to claim 192 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

195. A system according to claim 192 and wherein said communications quality ameliorator is portable.

196. A system according to claim 195 and wherein said communication quality ameliorator provides at least one of the following functionalities:
a communication security functionality;
a performance amelioration functionality;
a communication availability functionality; and
a communication accountability functionality.

197. A system according to claim 195 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

198. A system according to claim 192 and wherein said communications quality ameliorator is stationary.

199. A system according to claim 198 and wherein said communication quality ameliorator provides at least one of the following functionalities:
a communication security functionality;
a performance amelioration functionality;
a communication availability functionality; and
a communication accountability functionality.

200. A system according to claim 198 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

201. A system according to claim 192 and wherein said second interaction comprises at least principally of BLUETOOTH® communication.

202. A system according to claim 201 and wherein said communication quality ameliorator provides at least one of the following functionalities:
a communication security functionality;
a performance amelioration functionality;
a communication availability functionality; and
a communication accountability functionality.

203. A system according to claim 201 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

204. A system according to claim 192 and wherein said first interaction includes at least some non-BLUETOOTH® communication between said access point and said at least one first device.

205. A system according to claim 128 and wherein both said first and second interactions comprise at least principally of BLUETOOTH® communication.

206. A system according to claim 205 and wherein said communication quality ameliorator provides a communication security functionality.

207. A system according to claim 205 and wherein said communication quality ameliorator provides a communication performance amelioration functionality.

208. A system according to claim 205 and wherein said communication quality ameliorator provides a communication availability functionality.

209. A system according to claim 205 and wherein said communication quality ameliorator provides a communication accountability functionality.

210. A system according to claim 205 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

211. A system according to claim 205 and wherein said communications quality ameliorator is portable.

212. A system according to claim 211 and wherein said communication quality ameliorator provides a communication security functionality.

213. A system according to claim 211 and wherein said communication quality ameliorator provides a communication performance amelioration functionality.

214. A system according to claim 211 and wherein said communication quality ameliorator provides a communication availability functionality.

215. A system according to claim 211 and wherein said communication quality ameliorator provides a communication accountability functionality.

216. A system according to claim 211 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

219. A system according to claim 205 and wherein said communications quality ameliorator is stationary.

220. A system according to claim 219 and wherein said communication quality ameliorator provides a communication security functionality.

221. A system according to claim 219 and wherein said communication quality ameliorator provides a communication performance amelioration functionality.

222. A system according to claim 219 and wherein said communication quality ameliorator provides a communication availability functionality.

223. A system according to claim 219 and wherein said communication quality ameliorator provides a communication accountability functionality.

224. A system according to claim 219 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

225. A system according to claim 128 and wherein both said at least one first device comprises a server.

226. A system according to claim 225 and wherein said communication quality ameliorator provides at least one of the following functionalities:
a communication security functionality;
a performance amelioration functionality;
a communication availability functionality; and
a communication accountability functionality.

227. A system according to claim 225 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

228. A system according to claim 225 and wherein said communications quality ameliorator is portable.

229. A system according to claim 228 and wherein said communication quality ameliorator provides at least one of the following functionalities:
a communication security functionality;
a performance amelioration functionality;
a communication availability functionality; and
a communication accountability functionality.

230. A system according to claim 228 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

231. A system according to claim 225 and wherein said communications quality ameliorator is stationary.

232. A system according to claim 231 and wherein said communication quality ameliorator provides at least one of the following functionalities:
a communication security functionality;
a performance amelioration functionality;
a communication availability functionality; and
a communication accountability functionality.

233. A system according to claim 231 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

234. A system according to claim 225 and wherein said second interaction comprises at least principally of BLUETOOTH® communication.

235. A system according to claim 234 and wherein said communication quality ameliorator provides at least one of the following functionalities:
a communication security functionality;
a performance amelioration functionality;
a communication availability functionality; and
a communication accountability functionality.

236. A system according to claim 234 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

237. A system according to claim 225 and wherein said first interaction includes at least some non-BLUETOOTH® communication between said access point and said at least one first device.

238. A system according to claim 225 and wherein said at least one first device comprises a plurality of first devices.

239. A system according to claim 128 and wherein said at least one first device comprises at least one of:
a printer;
a web site;
a computer;
a computer screen;
a cordless telephone base unit;
an authenticator; and
a domestic appliance.

240. A system according to claim 128 and wherein both said at least one second device comprises a client.

241. A system according to claim 240 and wherein said communication quality ameliorator provides at least one of the following functionalities:
a communication security functionality;
a performance amelioration functionality;
a communication availability functionality; and
a communication accountability functionality.

242. A system according to claim 240 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

243. A system according to claim 240 and wherein said communications quality ameliorator is portable.

244. A system according to claim 243 and wherein said communication quality ameliorator provides at least one of the following functionalities:
a communication security functionality;
a performance amelioration functionality;
a communication availability functionality; and
a communication accountability functionality.

245. A system according to claim 243 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

246. A system according to claim 240 and wherein said communications quality ameliorator is stationary.

247. A system according to claim 246 and wherein said communication quality ameliorator provides at least one of the following functionalities:
a communication security functionality;
a performance amelioration functionality;
a communication availability functionality; and
a communication accountability functionality.

248. A system according to claim 246 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

249. A system according to claim 240 and wherein said second interaction comprises at least principally of BLUETOOTH® communication.

250. A system according to claim 249 and wherein said communication quality ameliorator provides at least one of the following functionalities:
a communication security functionality;
a performance amelioration functionality;
a communication availability functionality; and
a communication accountability functionality.

251. A system according to claim 249 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

252. A system according to claim 240 and wherein said first interaction includes at least some non-BLUETOOTH® communication between said access point and said at least one first device.

253. A system according to claim 240 and wherein said at least one second device comprises a plurality of second devices.

254. A system according to claim 128 and wherein said at least one second device comprises at least one of:
an electronic wallet;
a telephone;
a cordless telephone handset
a personal digital assistant;
a portable computer;
a keyboard;
a mouse; and
a remote controller.

255. A communications quality ameliorator including:
a first interface providing interaction with at least one first device; and
a second interface providing interaction with at least one second device, said interaction including at least BLUETOOTH® communication.

256. A communications quality ameliorator according to claim 255 and wherein said communication quality ameliorator provides a communication security functionality.

257. A communications quality ameliorator according to claim 255 and wherein said communication quality ameliorator provides a communication performance amelioration functionality.

258. A communications quality ameliorator according to claim 255 and wherein said communication quality ameliorator provides a communication availability functionality.

259. A communications quality ameliorator according to claim 255 and wherein said communication quality ameliorator provides a communication accountability functionality.

260. A communications quality ameliorator according to claim 255 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

261. A communications quality ameliorator according to claim 255 and wherein said communications quality ameliorator is portable.

262. A communications quality ameliorator according to claim 261 and wherein said communication quality ameliorator provides at least one of the following functionalities:
a communication security functionality;
a performance amelioration functionality;
a communication availability functionality; and
a communication accountability functionality.

263. A communications quality ameliorator according to claim 261 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

264. A communications quality ameliorator according to claim 255 and wherein said communications quality ameliorator is stationary.

265. A communications quality ameliorator according to claim 264 and wherein said communication quality ameliorator provides at least one of the following functionalities:
a communication security functionality;
a performance amelioration functionality;
a communication availability functionality; and
a communication accountability functionality.

266. A communications quality ameliorator according to claim 264 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

267. A communications quality ameliorator according to claim 255 and wherein said second interaction comprises at least principally of BLUETOOTH® communication.

268. A communications quality ameliorator according to claim 267 and wherein said communication quality ameliorator provides at least one of the following functionalities:
a communication security functionality;
a performance amelioration functionality;
a communication availability functionality; and
a communication accountability functionality.

269. A communications quality ameliorator according to claim 267 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

270. A communications quality ameliorator according to claim 267 and wherein said communications quality ameliorator is portable.

271. A communications quality ameliorator according to claim 270 and wherein said communication quality ameliorator provides at least one of the following functionalities:
a communication security functionality;
a performance amelioration functionality;
a communication availability functionality; and
a communication accountability functionality.

272. A communications quality ameliorator according to claim 270 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

273. A communications quality ameliorator according to claim 267 and wherein said communications quality ameliorator is stationary.

274. A communications quality ameliorator according to claim 273 and wherein said communication quality ameliorator provides at least one of the following functionalities:
a communication security functionality;
a performance amelioration functionality;
a communication availability functionality; and
a communication accountability functionality.

275. A communications quality ameliorator according to claim 273 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

276. A communications quality ameliorator according to claim 255 and wherein said first interaction includes at least some non-BLUETOOTH® communication.

277. A communications quality ameliorator according to claim 276 and wherein said communication quality ameliorator provides at least one of the following functionalities:
a communication security functionality;
a performance amelioration functionality;
a communication availability functionality; and
a communication accountability functionality.

278. A communications quality ameliorator according to claim 276 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

279. A communications quality ameliorator according to claim 276 and wherein said communications quality ameliorator is portable.

280. A communications quality ameliorator according to claim 279 and wherein said communication quality ameliorator provides at least one of the following functionalities:
a communication security functionality;
a performance amelioration functionality;
a communication availability functionality; and
a communication accountability functionality.

281. A communications quality ameliorator according to claim 276 and wherein said communications quality ameliorator is stationary.

282. A communications quality ameliorator according to claim 276 wherein said second interaction comprises at least principally of BLUETOOTH® communication.

283. A communications quality ameliorator according to claim 255 and wherein said first interaction comprises at least principally of BLUETOOTH® communication with an access point.

284. A communications quality ameliorator according to claim 283 and wherein said communication quality ameliorator provides at least one of the following functionalities:
a communication security functionality;
a performance amelioration functionality;
a communication availability functionality; and
a communication accountability functionality.

285. A communications quality ameliorator according to claim 283 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

286. A communications quality ameliorator according to claim 283 and wherein said communications quality ameliorator is portable.

287. A communications quality ameliorator according to claim 286 and wherein said communication quality ameliorator provides at least one of the following functionalities:
a communication security functionality;
a performance amelioration functionality;
a communication availability functionality; and
a communication accountability functionality.

288. A communications quality ameliorator according to claim 283 and wherein said communications quality ameliorator is stationary.

289. A communications quality ameliorator according to claim 283 and wherein said second interaction comprises at least principally of BLUETOOTH® communication.

290. A communications quality ameliorator according to claim 289 and wherein said communication quality ameliorator provides at least one of the following functionalities:
a communication security functionality;
a performance amelioration functionality;
a communication availability functionality; and
a communication accountability functionality.

291. A communications quality ameliorator according to claim 283 and wherein said first interaction includes at least some non-BLUETOOTH® communication between said access point and said at least one first device.

292. A communications quality ameliorator according to claim 255 and wherein both said first and second interactions comprise at least principally of BLUETOOTH® communication.

293. A communications quality ameliorator according to claim 292 and wherein said communication quality ameliorator provides a communication security functionality.

294. A communications quality ameliorator according to claim 292 and wherein said communication quality ameliorator provides a communication performance amelioration functionality.

295. A communications quality ameliorator according to claim 292 and wherein said communication quality ameliorator provides a communication availability functionality.

296. A communications quality ameliorator according to claim 292 and wherein said communication quality ameliorator provides a communication accountability functionality.

297. A communications quality ameliorator according to claim 292 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

298. A communications quality ameliorator according to claim 292 and wherein said communications quality ameliorator is portable.

299. A communications quality ameliorator according to claim 298 and wherein said communication quality ameliorator provides at least one of the following functionalities:
a communication security functionality;
a performance amelioration functionality;
a communication availability functionality; and
a communication accountability functionality.

300. A communications quality ameliorator according to claim 292 and wherein said communications quality ameliorator is stationary.

301. A communications quality ameliorator according to claim 300 and wherein said communication quality ameliorator provides at least one of the following functionalities:
a communication security functionality;
a performance amelioration functionality;
a communication availability functionality; and
a communication accountability functionality.

302. A communications quality ameliorator comprising:
a first interface providing interaction with at least one first device; and
a second interface providing interaction with at least one second device, said second device being required to conduct certain communications only via said communications quality ameliorator, said interaction including at least BLUETOOTH® communication.

303. A communications quality ameliorator according to claim 302 and wherein said communication quality ameliorator provides a communication security functionality.

304. A communications quality ameliorator according to claim 302 and wherein said communication quality ameliorator provides a communication performance amelioration functionality.

305. A communications quality ameliorator according to claim 302 and wherein said communication quality ameliorator provides a communication availability functionality.

306. A communications quality ameliorator according to claim 302 and wherein said communication quality ameliorator provides a communication accountability functionality.

307. A communications quality ameliorator according to claim 302 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

308. A communications quality ameliorator according to claim 302 and wherein said communications quality ameliorator is portable.

309. A communications quality ameliorator according to claim 308 and wherein said communication quality ameliorator provides at least one of the following functionalities:
a communication security functionality;
a performance amelioration functionality;
a communication availability functionality; and
a communication accountability functionality.

310. A communications quality ameliorator according to claim 308 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

311. A communications quality ameliorator according to claim 302 and wherein said communications quality ameliorator is stationary.

312. A communications quality ameliorator according to claim 311 and wherein said communication quality ameliorator provides at least one of the following functionalities:
a communication security functionality;
a performance amelioration functionality;
a communication availability functionality; and
a communication accountability functionality.

313. A communications quality ameliorator according to claim 311 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

314. A communications quality ameliorator according to claim 302 and wherein said second interaction comprises at least principally of BLUETOOTH® communication.

315. A communications quality ameliorator according to claim 314 and wherein said communication quality ameliorator provides at least one of the following functionalities:
a communication security functionality;
a performance amelioration functionality;
a communication availability functionality; and
a communication accountability functionality.

316. A communications quality ameliorator according to claim 314 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

317. A communications quality ameliorator according to claim 314 and wherein said communications quality ameliorator is portable.

318. A communications quality ameliorator according to claim 317 and wherein said communication quality ameliorator provides at least one of the following functionalities:
a communication security functionality;
a performance amelioration functionality;
a communication availability functionality; and
a communication accountability functionality.

319. A communications quality ameliorator according to claim 317 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

320. A communications quality ameliorator according to claim 314 and wherein said communications quality ameliorator is stationary.

321. A communications quality ameliorator according to claim 320 and wherein said communication quality ameliorator provides at least one of the following functionalities:
a communication security functionality;
a performance amelioration functionality;
a communication availability functionality; and
a communication accountability functionality.

322. A communications quality ameliorator according to claim 320 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

323. A communications quality ameliorator according to claim 302 and wherein said first interaction includes at least some non-BLUETOOTH® communication.

324. A communications quality ameliorator according to claim 323 and wherein said communication quality ameliorator provides at least one of the following functionalities:
a communication security functionality;
a performance amelioration functionality;
a communication availability functionality; and
a communication accountability functionality.

325. A communications quality ameliorator according to claim 323 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

326. A communications quality ameliorator according to claim 323 and wherein said communications quality ameliorator is portable.

327. A communications quality ameliorator according to claim 326 and wherein said communication quality ameliorator provides at least one of the following functionalities:
a communication security functionality;
a performance amelioration functionality;
a communication availability functionality; and
a communication accountability functionality.

328. A communications quality ameliorator according to claim 323 and wherein said communications quality ameliorator is stationary.

329. A communications quality ameliorator according to claim 323 wherein said second interaction comprises at least principally of BLUETOOTH® communication.

330. A communications quality ameliorator according to claim 302 and wherein said first interaction comprises at least principally of BLUETOOTH® communication with an access point.

331. A communications quality ameliorator according to claim 330 and wherein said communication quality ameliorator provides at least one of the following functionalities:
a communication security functionality;
a performance amelioration functionality;
a communication availability functionality; and
a communication accountability functionality.

332. A communications quality ameliorator according to claim 330 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

333. A communications quality ameliorator according to claim 330 and wherein said communications quality ameliorator is portable.

334. A communications quality ameliorator according to claim 333 and wherein said communication quality ameliorator provides at least one of the following functionalities:
a communication security functionality;
a performance amelioration functionality;
a communication availability functionality; and
a communication accountability functionality.

335. A communications quality ameliorator according to claim 330 and wherein said communications quality ameliorator is stationary.

336. A communications quality ameliorator according to claim 330 and wherein said second interaction comprises at least principally of BLUETOOTH® communication.

337. A communications quality ameliorator according to claim 336 and wherein said communication quality ameliorator provides at least one of the following functionalities:
a communication security functionality;
a performance amelioration functionality;
a communication availability functionality; and
a communication accountability functionality.

338. A communications quality ameliorator according to claim 330 and wherein said first interaction includes at least some non-BLUETOOTH® communication between said access point and said at least one first device.

339. A communications quality ameliorator according to claim 302 and wherein both said first and second interactions comprise at least principally of BLUETOOTH® communication.

340. A communications quality ameliorator according to claim 339 and wherein said communication quality ameliorator provides a communication security functionality.

341. A communications quality ameliorator according to claim 339 and wherein said communication quality ameliorator provides a communication performance amelioration functionality.

342. A communications quality ameliorator according to claim 339 and wherein said communication quality ameliorator provides a communication availability functionality.

343. A communications quality ameliorator according to claim 339 and wherein said communication quality ameliorator provides a communication accountability functionality.

344. A communications quality ameliorator according to claim 339 and wherein said communication quality ameliorator includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

345. A communications quality ameliorator according to claim 339 and wherein said communications quality ameliorator is portable.

346. A communications quality ameliorator according to claim 345 and wherein said communication quality ameliorator provides at least one of the following functionalities:
a communication security functionality;
a performance amelioration functionality;
a communication availability functionality; and
a communication accountability functionality.

347. A communications quality ameliorator according to claim 339 and wherein said communications quality ameliorator is stationary.

348. A communications quality ameliorator according to claim 347 and wherein said communication quality ameliorator provides at least one of the following functionalities:
a communication security functionality;
a performance amelioration functionality;
a communication availability functionality; and
a communication accountability functionality.

349. A method for use in a communication network comprising, said method comprising:
at least one amelioration functionality;
a first interaction between said at least one amelioration functionality and at least one first device; and
a second interaction between said at least one amelioration functionality and at least one second device, said second interaction including at least BLUETOOTH® communication.

350. A method according to claim 349 and wherein said amelioration functionality includes a communication security functionality.

351. A method according to claim 349 and wherein said amelioration functionality includes a communication performance amelioration functionality.

352. A method according to claim 349 and wherein said amelioration functionality includes a communication availability functionality.

353. A method according to claim 349 and wherein said amelioration functionality includes a communication accountability functionality.

354. A method according to claim 349 and wherein said amelioration functionality includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

355. A method according to claim 349 and wherein said second interaction comprises at least principally of BLUETOOTH® communication.

356. A method according to claim 355 and wherein said amelioration functionality includes at least one of the following functionalities:
a communication security functionality;
a performance amelioration functionality;
a communication availability functionality; and
a communication accountability functionality.

357. A method according to claim 355 and wherein said amelioration functionality includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

358. A method according to claim 349 and wherein said first interaction includes at least some non-BLUETOOTH® communication.

359. A method according to claim 358 and wherein said amelioration functionality includes at least one of the following functionalities:
a communication security functionality;
a performance amelioration functionality;
a communication availability functionality; and
a communication accountability functionality.

360. A method according to claim 358 and wherein said amelioration functionality includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

361. A method according to claim 358 wherein said second interaction comprises at least principally of BLUETOOTH® communication.

362. A method according to claim 349 and wherein said first interaction comprises at least principally of BLUETOOTH® communication with an access point.

363. A method according to claim 362 and wherein said amelioration functionality includes at least one of the following functionalities:
a communication security functionality;
a performance amelioration functionality;
a communication availability functionality; and
a communication accountability functionality.

364. A method according to claim 362 and wherein said amelioration functionality includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.

365. A method according to claim 362 and wherein said second interaction comprises at least principally of BLUETOOTH® communication.

366. A method according to claim 365 and wherein said amelioration functionality includes at least one of the following functionalities:
a communication security functionality;
a performance amelioration functionality;
a communication availability functionality; and
a communication accountability functionality.

367. A method according to claim 362 and wherein said first interaction includes at least some non-BLUETOOTH® communication between said access point and said at least one first device.

368. A method according to claim 349 and wherein both said first and second interactions comprise at least principally of BLUETOOTH® communication.

369. A method according to claim 368 and wherein said amelioration functionality includes a communication security functionality.

370. A method according to claim 368 and wherein said amelioration functionality includes a communication performance amelioration functionality.

371. A method according to claim 368 and wherein said amelioration functionality includes a communication availability functionality.

372. A method according to claim 368 and wherein said amelioration functionality includes a communication accountability functionality.

373. A method according to claim 368 and wherein said amelioration functionality includes at least one of the following functionalities:
a communication monitoring functionality;
an accounting functionality;
a billing functionality;
a firewall functionality;
a content inspection functionality;
a proxy functionality;
a caching functionality;
a quality of service functionality;
an encryption functionality;
an authentication functionality; and
a load balancing functionality.
